(19) United States
(12) Patent Application Publication
(10) Pub. No.: US 2018/0315338 A1
(43) Pub. Date: Nov. 1, 2018

(54) WATCH-TYPE MOBILE TERMINAL AND OPERATING METHOD THEREFOR

(71) Applicant: LG ELECTRONICS INC., Seoul (KR)

(72) Inventors: Yoonchan WON, Seoul (KR); Byoungzoo JEONG, Seoul (KR); Eugene MYUNG, Seoul (KR); Nayeoung KIM, Seoul (KR)

(73) Assignee: LG ELECTRONICS INC., Seoul (KR)

(21) Appl. No.: 15/770,056

(22) PCT Filed: Oct. 22, 2015
(86) PCT No.: PCT/KR2015/011240

§ 371 Date: Apr. 20, 2018

(51) Int. Cl. G09B 19/00; H04B 1/3827; A63B 71/06

(52) U.S. Cl. CPC G09B 19/0038; A63B 71/0686; H04B 1/385

(57) ABSTRACT

An operating method for a watch-type mobile terminal is disclosed. The operating method for a watch-type mobile terminal, according to an embodiment of the present invention, comprises the steps of: acquiring an exercise guide including information on the exercise pace of a guider; acquiring exercise information of a user; and outputting a tactile signal for guiding the user to do the exercise at the exercise pace of the guider, on the basis of the exercise guide and the exercise information.

### TECHNICAL FIELD

The present disclosure relates to a watch-type mobile terminal capable of guiding an exercise pace of a user by using a tactile signal, and an operating method therefor.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

The mobile terminals are mostly held in the hands and are used by a user, and furthermore, may be expanded to wearable devices which may be worn on the body of the user. Examples of such a wearable device include a watch-type mobile terminal, a glass-type mobile terminal, a head mounted display (HMD), and the like.

Among the mobile terminals, the watch-type mobile terminal is a mobile terminal in which an electronic function, a communication function, a multimedia function, and the like are added to a watch always worn by people. Since the watch-type mobile terminal does not cause negative feeling to people, it appears that the market for the watch-type mobile terminal is explosively created in the future.

Therefore, a research, a development, and commercialization of the watch-type mobile terminal are actively conducted.

Meanwhile, recently, as interest in an exercise has increased, a plurality of users of mobile terminals have acquired exercise records using the mobile terminals and have increasingly shared the acquired exercise records with one another.

However, in the past, since only sketchy information on exercise records such as a distance for each course, an elapsed time for each course, and the like has been shared, users could only share exercise results thereof and could not share and use accurate exercise paces during an exercise.

In addition, in the past, since exercise results have been quantified and shared so as to be visually confirmed, a user immersed in an exercise could not easily confirm exercise paces of other people.

### DISCLOSURE OF THE INVENTION

### Technical Problem

Embodiments of the present disclosure are directed to provide a watch-type mobile terminal capable of guiding an exercise pace of a user by using a tactile effect, and an operating method therefor.

### Technical Solution

In one embodiment, an operating method of a watch-type mobile terminal includes: acquiring an exercise guide including information on an exercise pace of a guider; acquiring exercise information of a user; and outputting a tactile signal for guiding the user to exercise at the exercise pace of the guider based on the exercise guide and the exercise information.

In another embodiment, a watch-type mobile terminal includes: a sensing unit configured to sense a motion of a user; an output unit configured to output a tactile signal; and a controller configured to control the output unit to output a tactile signal for guiding the user to exercise at an exercise pace of the guider by using exercise information of the user acquired based on an exercise guide including information on the exercise pace of the guider and the sensed motion of the user.

### Advantageous Effects

According to the present disclosure, since a signal for guiding an exercise of a user is output in the form of a tactile signal, the exercise of the user may be guided without interfering with the exercise of the user.

### BRIEF DESCRIPTION OF THE DRAWINGS

FIG. 1 is a block diagram illustrating a mobile terminal according to the present disclosure.

FIG. 2 is a perspective view illustrating one example of a watch-type mobile terminal according to the present disclosure.

FIG. 3 is a flowchart of an operating method of a mobile terminal, according to an embodiment of the present disclosure.

FIG. 4 is a graph showing information on a pace included in an exercise guide according to an embodiment of the present disclosure.

FIGS. 5A to 11B are diagrams illustrating a method of outputting a tactile signal for guiding an exercise pace of a user based on an exercise guide and exercise information of the user, according to an embodiment of the present disclosure.

FIG. 12 is a diagram illustrating a method of displaying an object corresponding to an exercise pace of guider, according to an embodiment of the present disclosure.

FIG. 13 is a flowchart of a method of acquiring an exercise guide when a guider is a user of each of the other mobile terminals, according to an embodiment of the present disclosure.

FIG. 14 is a diagram illustrating a screen on which pieces information respectively corresponding to a plurality of exercise guides received from a server are displayed.

FIG. 15 is a diagram illustrating a method of receiving a user input of selecting information corresponding to a specific exercise guide from pieces of displayed information respectively corresponding to a plurality of exercise guides.

FIGS. 16A and 16B are diagrams illustrating a method of generating an exercise guide of a user of a watch-type mobile terminal (100), transmitting the generated exercise guide to a server, and sharing the exercise guide of the user with other people.

FIGS. 17A to 20 are diagrams illustrating a method of sharing a diet guide, according to another embodiment of the present disclosure.

FIG. 21 is a diagram illustrating an operating method of a wearable device, according to another embodiment of the present disclosure.

FIGS. 22A and 22B are diagrams illustrating an operating method of a wearable device, according to another embodiment of the present disclosure.

FIG. 23 is a diagram illustrating a method of guiding an exercise of a user by using an exercise guide of a guider.

FIGS. 24A to 26 are diagrams illustrating operation of a smartband in a mode in which a user competes with one guider, according to an embodiment of the present disclosure.

FIGS. 27 to 30B are diagrams illustrating operation of a smartband in a mode in which a user competes with a plurality of guiders, according to an embodiment of the present disclosure.

FIGS. 31A to 31C are diagrams illustrating operation of a smartband in a mode in which a user competes with a plurality of guiders, according to another embodiment of the present disclosure.

### MODE FOR CARRYING OUT THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

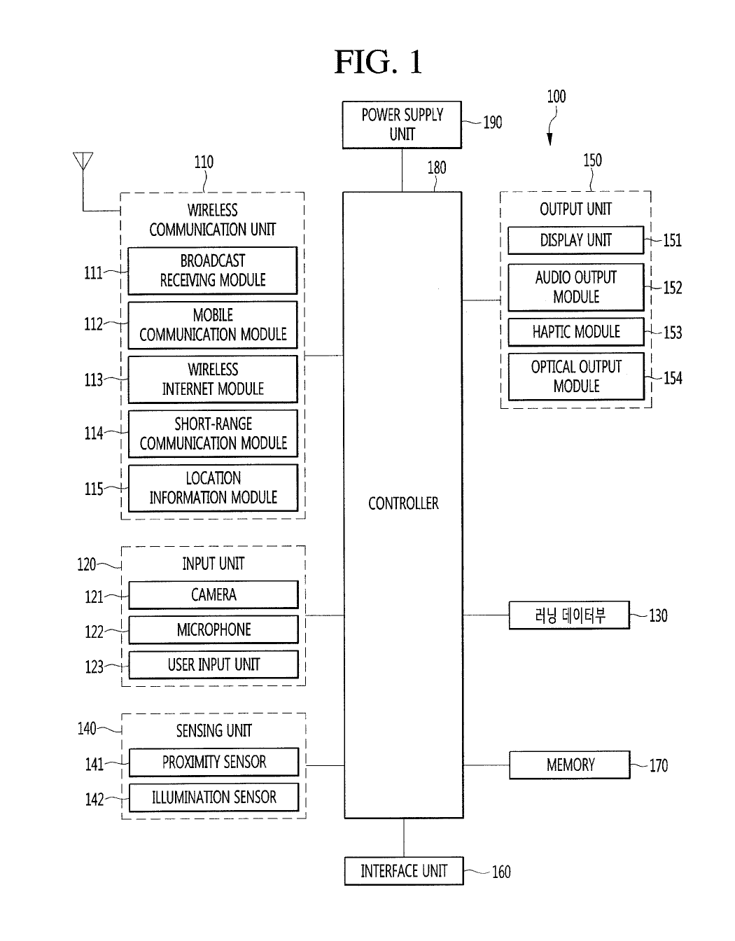

Reference is now made to FIG. 1, where FIG. 1 is a block diagram of a mobile terminal in accordance with the present disclosure.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIG. 1 according to the execution of an application program that have been stored in the memory 170. The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least some of the above components may operate in a cooperating manner, so as to implement an operation, control, or a control method of the mobile terminal according to various embodiments to be described later. In addition, the operation, the control, or the control method of the mobile terminal may be implemented on the mobile terminal by driving at least one application program stored in the memory 170.

Referring still to FIG. 1, various components depicted in this figure will now be described in more detail.

Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like).

Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the wireless Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB(Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

The short-range communication module 114 may sense (or recognize) other mobile terminals which are located around the mobile terminal 100 and are capable of communicating with the mobile terminal 100. Furthermore, when other mobile terminals are a device which is authenticated to communicate with the mobile terminal 100, the controller 180 may transmit at least a portion of data processed in the mobile terminal 100 to other mobile terminals through the short-range communication module 114. Therefore, users of other mobile terminals may use the data processed in the mobile terminal 100 through other mobile terminals. For example, when a call is received in the mobile terminal 100, a user may answer the call through other mobile terminals. When a message is received in the mobile terminal 100, the may check the received message through other mobile terminals.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 100. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sensing unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor (142) can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor (142) may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

A communication system which is operable with the variously described mobile terminals will now be described in more detail. Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A(Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM (Orthogonal Frequency Division Multiplexing) wireless communication system. A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.”

Alternatively, individual sectors of a given base station may be referred to as cell sites.

A broadcasting transmitter (BT) transmits a broadcast signal to the mobile terminals 100 operating within the system. The broadcast receiving module 111 of FIG. 1A is typically configured inside the mobile terminal 100 to receive broadcast signals transmitted by the BT.

Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. If desired, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites.

Furthermore, the GPS module can acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module.

The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server. The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database.

A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter.

In addition to these position location methods, various algorithms may be used to extract (analyze) location information of a mobile terminal. Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

Various embodiments described herein may be implemented in a computer-readable medium, a machine-readable medium, or similar medium using, for example, software, hardware, or any combination thereof.

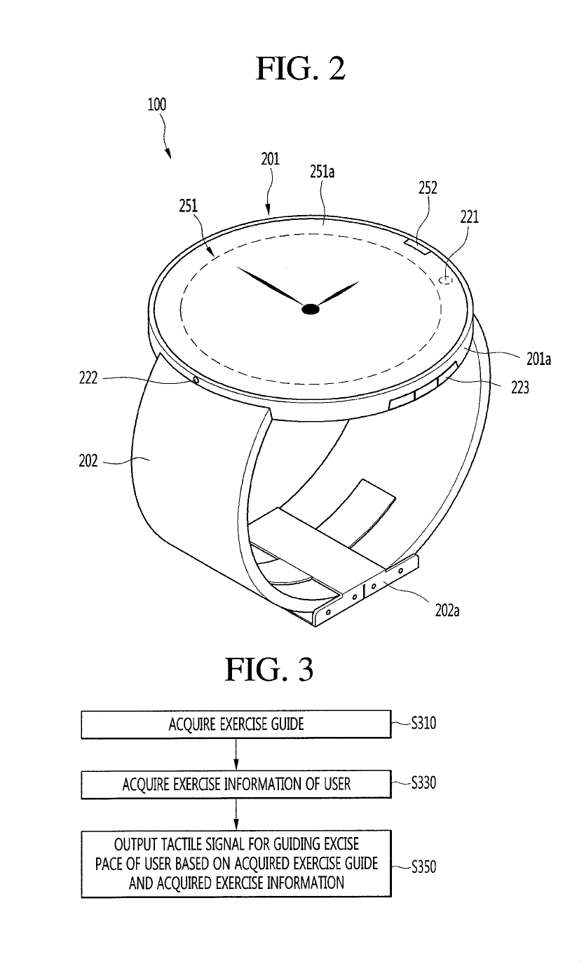

FIG. 2 is a perspective view illustrating one example of a watch-type mobile terminal according to the present disclosure.

A watch-type mobile terminal 100 illustrated in FIG. 2 may include all elements illustrated in FIG. 1.

A display unit 251 of the watch-type mobile terminal 100 may have a circular shape, but is not limited thereto. The display unit 251 may have an oval shape and a quadrangular shape. The shape of the display unit 251 of the present disclosure may include any shape that may provide a visually good expression to a user and assist the user in manipulating a touch screen.

As illustrated in FIG. 2, the watch-type mobile terminal 100 includes a main body 201 with a display unit 251 and a band 202 connected to the main body 201 to be wearable on a wrist.

The main body 201 may include a case having a certain appearance. As illustrated, the case may include a first case 301a and a second case 301b cooperatively defining an inner space for accommodating various electronic components. Other configurations are possible. For instance, a single case may alternatively be implemented, with such a case being configured to define the inner space, thereby implementing a mobile terminal 300 with a uni-body.

The watch-type mobile terminal 100 can perform wireless communication, and an antenna for the wireless communication can be installed in the main body 201. The antenna may extend its function using the case. For example, a case including a conductive material may be electrically connected to the antenna to extend a ground area or a radiation area.

The display unit 251 is shown located at the front side of the main body 201 so that displayed information is viewable to a user. In some embodiments, the display unit 251 includes a touch sensor so that the display unit can function as a touch screen. As illustrated, window 251a is positioned on the first case 201a to form a front surface of the terminal body together with the first case 201a.

The illustrated embodiment includes audio output module 252, a camera 221, a microphone 222, and a user input unit 223 positioned on the main body 201. When the display unit 251 is implemented as a touch screen, additional function keys may be minimized or eliminated. For example, when the touch screen is implemented, the user input unit 223 may be omitted.

The band 202 is commonly worn on the user's wrist and may be made of a flexible material for facilitating wearing of the device. As one example, the band 202 may be made of fur, rubber, silicon, synthetic resin, or the like. The band 202 may also be configured to be detachable from the main body 201. Accordingly, the band 202 may be replaceable with various types of bands according to a user's preference.

In one configuration, the band 202 may be used for extending the performance of the antenna. For example, the band may include therein a ground extending portion (not shown) electrically connected to the antenna to extend a ground area.

The band 202 may include fastener 202a. The fastener 202a may be implemented into a buckle type, a snap-fit hook structure, a Velcro® type, or the like, and include a flexible section or material. The drawing illustrates an example that the fastener 202a is implemented using a buckle.

FIG. 3 is a flowchart of an operating method of a watch-type mobile terminal, according to an embodiment of the present disclosure.

Meanwhile, it is described that the present disclosure is implemented in a mobile terminal of a watch-type mobile terminal, but the present disclosure is not limited thereto. For example, the present disclosure may be implemented in all electronic devices, such as a smartband and a mobile terminal, which are capable of transferring a tactile signal to a user.

According to FIG. 3, the operating method of the watch-type mobile terminal may include acquiring an exercise guide including information on an exercise pace of a guider (S310), acquiring exercise information of a user (S330), and outputting a tactile signal for guiding the user to exercise at an exercise pace of the guider based on the exercise guide and the exercise information of the user (S350).

Among the steps, the acquiring of the exercise guide of the guider (S310) will be described.

An exercise guide may include information on a plurality of positions. Here, when a guider moves while exercising, the information on the plurality of positions may be information on a plurality of positions on a movement route of the guider. For example, when the guider moves from point a to point b while exercising along a specific route, the information on the plurality of positions may be information on a plurality of positions present between point a and point b on the specific route.

Meanwhile, the “guider” may be a person exercising on an exercise guide, and the exercise guide may be a guide generated based on exercise information of the “guider”. That is, the exercise guide may include pieces of exercise information of the “guider”. On the other hand, the exercise information may include at least one of information on a plurality of positions on a movement route of the guider, information on a plurality of exercise paces respectively corresponding to the plurality of positions, information on a plurality of times elapsed since the guider started to exercise, and information on a plurality of exercise paces respectively corresponding to the plurality of times.

Here, the “guider” may be a user of the watch-type mobile terminal 100. Specifically, when an exercise guide is generated based on past exercise information of the user of the watch-type mobile terminal 100, the “guider” may be the user of the watch-type mobile terminal 100. In this case, information on an exercise pace of the guider may be information on an exercise pace acquired based on the past exercise information of the user.

In addition, the “guider” may be a user of each of other mobile terminals. Specifically, when the exercise guide is generated based on past exercise information of the user of each of other mobile terminals, the “guider” may be the user of each of other mobile terminals. In this case, information on an exercise pace of the guider may be information on an exercise pace acquired based on exercise information of the user of each of other mobile terminals.

The exercise guide generated based on an exercise record of the user of each of other mobile terminals may be received from other terminals or through a server. Descriptions thereof will be described in detail below.

Meanwhile, the “guider” may be a virtual person. For example, when an exercise guide is virtually generated by an exercise guide provider, the “guider” may be the virtual person.

When the guider moves while exercising, information on a plurality of positions on a movement route of the guider may be information on a plurality of positions through which the guider passes. Here, the information of the plurality of positions may include GPS information on each of the plurality of positions. The present disclosure is not limited thereto, and the information of the plurality of positions may include all information capable of determining a position of a mobile terminal.

Meanwhile, an exercise guide may include information on a plurality of exercise paces respectively corresponding to a plurality of positions. Here, when the guider moves while exercising, the information on the plurality of exercise paces respectively corresponding to the plurality of positions may be information on an exercise pace of the guider at each of a plurality of positions on a movement route of the guide. For example, when the guider passes through a first position, a second position, and a third position while exercising along a specific route, information on a plurality of paces may include information on an exercise pace of the guider at the first position, information on an exercise pace of the guider at the second position of the guider, and information on an exercise pace of the guider at the third position.

Here, information on an exercise pace may be information on movement speed. For example, when the guider passes through the first position, the second position, and the third position while exercising along the specific route, the information on the plurality of paces may include information on movement speed of the guider at the first position, information on movement speed of the guider at the second position, and information on movement speed of the guider at the third position.

In addition, information on an exercise pace may be information on the number of motions per unit time.

The information on the number of motions unit time may be information on the number of walks per unit time. For example, when the guider passes through the first position, the second position, and the third position while exercising along the specific route, the information on the plurality of paces may include information on the number of walks per unit time of the guider at the first position, information on the number of walks per unit time of the guider at the second position, and information on the number of walks per unit time of the guider at the third position.

Here, a walk is an action in which the guider moves a body through a continuous movement of a joint and a muscle. The walk may include a walking or running motion through the movement of the joint and the muscle.

In an example, the number of walks per unit time may be 80 times/min when the guider takes 80 steps for one minute.

On the other hand, the information on the number of motions per unit time may be information on the number of rotations per unit time. For example, when the guider riding a bicycle passes through the first position, the second position, and the third position present on the specific route by rotating a pedal of the bicycle, the information on the plurality of paces may include information on the number of rotations per unit time of the guider at the first position, information on the number of rotations per unit time of the guider at the second position, and information on the number of rotations per unit time of the guider at the third position.

In an example, the number of rotations per unit time may be revolution per minute (RPM). For example, when the guider rotates the pedal 120 times for one minute, the number of rotations per unit time may be 120 RPM.

In addition, information on an exercise pace may be information on steps of the guider in a specific course corresponding to a specific position. For example, descriptions assume that the guider passes through the first position, the second position, and the third position while exercising along the specific route, a course corresponding to the second position may be a course between the second position and the third position.

Meanwhile, information on a plurality of exercise paces respectively corresponding to a plurality of positions may be information on steps of the guider in a plurality of courses respectively corresponding to the plurality of positions. For example, the information on the plurality of exercise paces respectively corresponding to the plurality of positions may include information on steps of the guider in a course corresponding to the first position (course between the first position and the second position), information on steps of the guider in a course corresponding to the second position (course between the second position and the third position), and information on steps of the guider in a course corresponding to the third position (course between the third position and a fourth position).

Meanwhile, an exercise guide may include information on a plurality of times elapsed since the guider started to exercise. For example, when a first time and a second time have elapsed since the guider started to exercise, the exercise guide may include information on the first time elapsed since the guider started to exercise and information on the second time elapsed since the guider started to exercise.

In addition, the exercise guide may include the information on the plurality of exercise paces respectively corresponding to the plurality of times elapsed since the guider started t exercise.

For example, when the first time and the second time have elapsed since the guider started to exercise, the information on the plurality of exercise paces may include information on an exercise pace of the guider when one hour has elapsed since the guider started to exercise and information on an exercise pace of the guider when the second time has elapsed since the guider started to exercise. Here, the information on the exercise pace may be information on a speed or information on the number of motions per unit time.

In another example, when the first time, the second time, and a third time have elapsed since the guider started to exercise, the information on the plurality of exercise paces may include information on steps of the guider in a course corresponding to the first time elapsed since the guider started to exercise, information on steps of the guider in a course corresponding to the second time elapsed since the guider started to exercise, and information on steps of the guider in a course corresponding to the third time elapsed since the guider started to exercise. Here, the information on steps of the guider in the course corresponding to the second time may be information on steps of the guider in a course from a time when the second time has elapsed to a time when the third time has elapsed, after the guider starts to exercise.

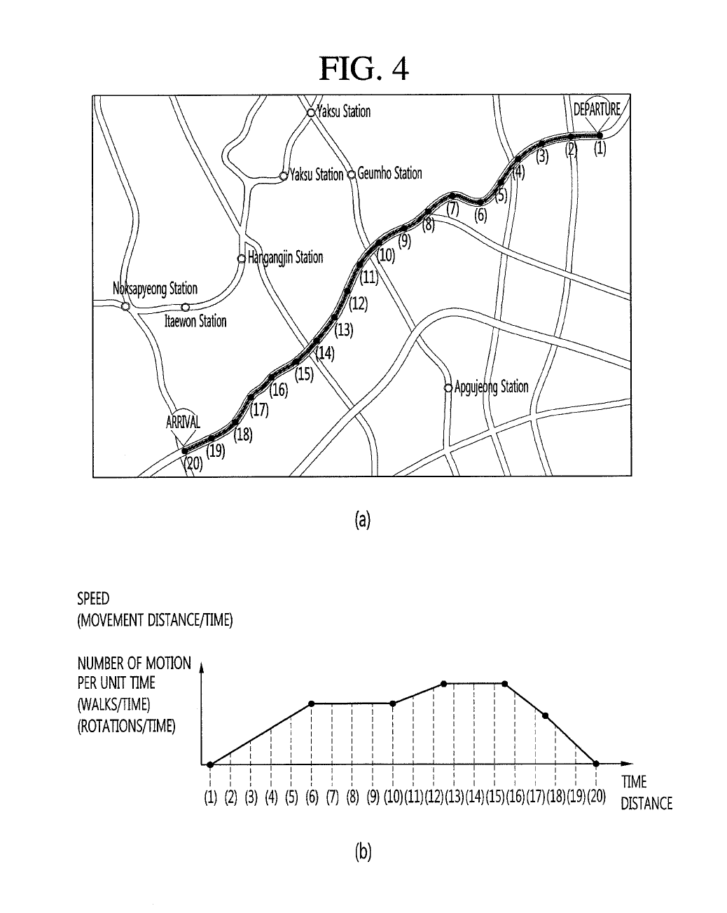

FIG. 4 is a graph showing information on a pace included in the exercise guide according to an embodiment of the present disclosure.

Here, A Y-axis is an axis representing information on an exercise pace (speed and number of motions per unit time) of the guider. Meanwhile, an X-axis may be an axis representing a movement time or a movement distance after the guider starts to exercise.

Position (1) is a position at which the guider starts to exercise, and an exercise guide may include position information on position (1) and information on an exercise pace (for example, a speed: 0 and the number of walks per unit time: 0) of the guider at position (1).

Positions (2) to (6) may be points through which the guider passes while increasing an exercise pace after starting to exercise, and an exercise guide may include position information on positions (2) to (6) and information on an exercise pace of the guider at each of positions (2) and (6). For example, the exercise guide may include position information at position (2) and information on a pace (for example, speed: 1 km/s) at position (2), position information at position (3) and information on a pace (for example, speed: 2 km/s) at position (3), position information at position (4) and information on a pace (for example, speed: 3 km/s) at position (4), position information at position (5) and information on a pace (for example, speed: 4 km/s) at position (5), and position information at position (6) and information on a pace (for example, speed: 5 km/s) at position (6).

Positions (7) to (10) may be positions through which the guider passes while maintaining an exercise pace after starting to exercise, and an exercise guide may include position information on positions (7) to (10) and information on an exercise pace of the guider at each of positions (7) and (10). For example, the exercise guide may include position information at position (7) and information on a pace (for example, speed: 5 km/s) at position (7), position information at position (8) and information on a pace (for example, speed: 5 km/s) at position (8), position information at position (9) and information on a pace (for example, speed: 5 km/s) at position (9), and position information at position (10) and information on a pace (for example, speed: 5 km/s) at position (10).

In addition, an exercise guide may include information on a plurality of positions and information on exercise paces of the guider respectively corresponding to the plurality of positions with respect to the remaining positions (11) to (20).

On the other hand, for convenience of description, in FIG. 4, it has been described that the exercise guide includes the position information at positions (1) to (20) and the information on exercise paces at positions (1) to (20), but the number of pieces of position information and information on exercise paces corresponding to the positions is not limited.

Meanwhile, information on a plurality of positions and information on a plurality of exercise paces respectively corresponding to the plurality of positions included in an exercise guide may be information acquired every certain period. For example, the information on the plurality of positions may be information acquired by measuring positions of the guider every 2 seconds, and information on the plurality of paces may be information on exercise paces of the guider acquired by measuring the position of the guider every 2 seconds.

Meanwhile, it has been described that the information on the plurality of positions included in the exercise guide is the information acquired every certain period, the present disclosure is not limited thereto. The information on the plurality of positions may be information acquired in an unspecific time unit.

In addition, the information on the plurality of positions and the information on the plurality of exercise paces respectively corresponding to the plurality of positions included in the exercise guide may be information every certain distance. For example, the information on the plurality of positions may be information acquired by measuring the positions of the guider every 5 meters, and the information on the plurality of paces may be information on exercise paces of the guider acquired by measuring the position of the guider every 5 meters.

Meanwhile, it has been described that the information on the plurality of positions included in the exercise guide is the information acquired every certain distance, the present disclosure is not limited thereto. The information on the plurality of positions may be information acquired in an unspecific distance unit.

In addition, the information on the plurality of positions and the information on the plurality of exercise paces respectively corresponding to the plurality of positions included in the exercise guide may be position information at a time at which an exercise pace of the guider is changed, and information on an exercise pace corresponding to the time. For example, when a user maintains a step period at 0.5 seconds and changes the step period from 0.5 seconds to 0.3 seconds and then changes the step period from 0.3 seconds to 0.4 seconds, position information included in the exercise guide may be position information at a time at which the step period of the user is changed from 0.5 seconds to 0.3 seconds, and information on an exercise pace corresponding to the time may be information on steps of the guider in a course from the time at which the step period of the user is changed from 0.5 seconds to 0.3 seconds to a time at which the step period of the user is changed from 0.3 seconds to 0.4 seconds.

Meanwhile, the information on the plurality of positions and the information on the plurality of exercise paces respectively corresponding to the plurality of positions included in the exercise guide have been described with reference to FIG. 4, but the present disclosure is not limited thereto. That is, the exercise guide may include information on a plurality of times elapsed since the guider started to exercise and information on a plurality of exercise paces respectively corresponding to the plurality of times elapsed since the guider started to exercise.

For example, the exercise guide may include information on a time when a first time (for example, 5 seconds) has elapsed since the guider started to exercise, and information on an exercise pace (for example, 3 km/h) corresponding to the first time, and information on a time when a second time (for example, 10 seconds) has elapsed since the guider started to exercise, and information on an exercise pace (for example, 5 km/h) corresponding to the second time.

In another example, the exercise guide may include information on a time when a first time (for example, 5 seconds) has elapsed since the guider started to exercise, and information on steps of the guider in a course corresponding to the first time (course between the first time and a second time), and information on a time when a second time (for example, 10 seconds) has elapsed since the guider started to exercise, and information on steps of the guider in a course corresponding to the second time (course between the second time and a third time).

Meanwhile, information on a plurality of times elapsed since the guider started to exercise and information on a plurality of exercise paces respectively corresponding to the plurality of times elapsed since the guider started to exercise may be information acquired every certain period. However, the present disclosure is not limited thereto, and the information on the plurality of times and the information on the plurality of exercise paces may be information acquired in an unspecific time unit.

Returning to FIG. 3 again, the operating method of the watch-type mobile terminal according to the embodiment of the present disclosure may include acquiring the exercise information of the user (S330).

The controller 180 may acquire exercise information of the user of the watch-type mobile terminal 100.

The exercise information of the user of the watch-type mobile terminal 100 may include information on an exercise pace of the user. Here, the information on the exercise pace of the user may include information on movement speed of the user or information on the number of motions per unit time of the user (information on the number of walks per unit time or information on the number of rotations per unit time).

Specifically, the sensing unit 140 senses a movement of the user, the controller 180 may acquire information on movement speed of the user based on a sensed result. In addition, when the sensing unit 140 senses a walk of the user or rotation of a leg of the user, the controller 180 may acquire information on the number of walks per unit time of the user or information on the number of rotations per unit timer of the user based on a sensed result.

Meanwhile, in order to acquire information on an exercise pace of the user, the sensing unit 140 may include various sensing means such as a gravity sensor (G-sensor), a geomagnetic sensor, a gyro sensor, an acceleration sensor, a tilt sensor, an altitude sensor, a depth sensor, a gyroscope sensor, an angular velocity sensor, a GPS sensor.

On the other hand, the exercise information of the user of the watch-type mobile terminal 100 may include information on a position of the user. Specifically, the controller 180 may acquire information on a position of the user by acquiring information on a position of the watch-type mobile terminal 100 through the wireless communication unit 110.

In addition, the exercise information of the user of the watch-type mobile terminal 100 may be information on a time elapsed since the user of the watch-type mobile terminal 100 started to exercise. Specifically, the controller 180 may acquire information indicating that the user starts to exercise, through a user input or sensing of a movement of the user. In addition, the controller 180 may acquire information on a time elapsed since the user started to exercise, by using a timer.

Meanwhile, the operating method of the watch-type mobile terminal according to the embodiment of the present disclosure may include outputting the tactile signal for guiding the exercise pace of the user based on the exercise guide and the exercise information of the user (S350).

The tactile signal may be output based on position information included in the exercise guide and the exercise information of the user.

In addition, the tactile signal may be output based on information on a plurality of times elapsed since an exercise has been started, included in the exercise guide, and information on a time elapsed since the user started to exercise, included in the exercise information of the user.

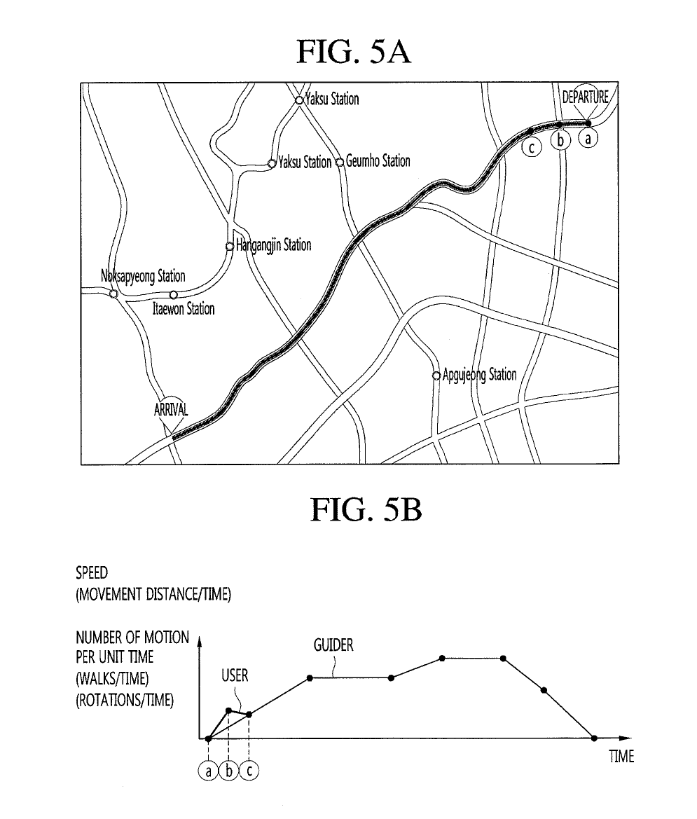

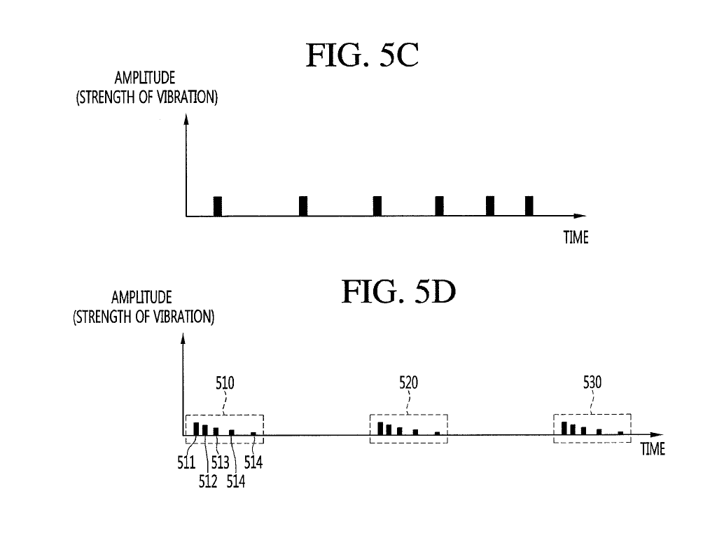

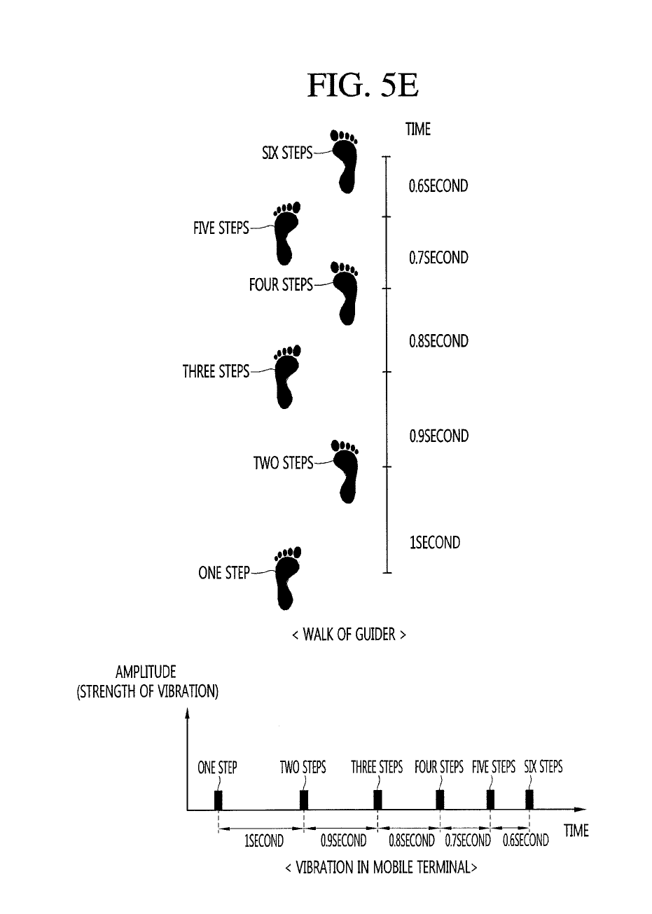

The outputting of the tactile signal for guiding the exercise pace of the user based on the exercise guide and the exercise information of the user (S350) will be described in detail with reference to FIGS. 5 to 10.

On the other hand, in FIGS. 5 to 11, it is assumed that the guider and the user exercise along the same route in the same course, but the present disclosure is not limited thereto. For example, when an exercise pace of the user is guided based on a plurality of times elapsed since the guider started to exercise and information on exercise paces respectively corresponding to the plurality of times elapsed since the guider started to exercise, although the guider and the user exercise along different routes, the watch-type mobile terminal 100 may guide the exercise guide of the user based on an exercise guide of the guider.

FIGS. 5 to 11 are diagrams illustrating a method of outputting a tactile signal for guiding an exercise pace of a user based on an exercise guide and exercise information of the user.

Position (a) of FIGS. 5A and 5B is a position at which a user starts to exercise. When the user exercises along the same route in the same course as a guider, position (a) at which the user starts to exercise may be the same as a position at which the guider starts to exercise.

Meanwhile, when the mobile terminal of the watch-type mobile terminal 100 is located at the position at which the guider starts to exercise, the controller 180 may output a notification indicating that the user starts to exercise according to an exercise guide, based on information on a position of the watch-type mobile terminal 100 acquired through the wireless communication unit 110.

On the other hand, the controller 180 may output a tactile signal for guiding a user located at a specific position of a plurality of positions included in the exercise guide to exercise according to an exercise pace of the guider corresponding to the specific position, based on information on a position of the user included in the exercise information of the user.

An operating method will be described when information on a plurality of paces respectively corresponding to a plurality of positions included in an exercise guide is information on movement speeds respectively corresponding to the plurality of positions.

When an exercise guide includes information on a plurality of positions and information on movement speeds respectively corresponding to the plurality of positions, the controller 180 may output a tactile signal for guiding a user located at a specific position of the plurality of positions included in the exercise guide to exercise at movement speed of a guider corresponding to the specific position.

For example, when movement speed of the guider is 2 km/h at position (b) of the plurality of positions included in the exercise guide, the controller 180 may output a tactile signal for guiding the user located at position (b) of the plurality of positions included in the exercise guide to exercise at movement speed (2 km/h) corresponding to position (b).

In this case, the controller 180 may acquire information on movement speed of the user at position (b). When the movement speed of the user at position (b) is greater than movement speed of the guider corresponding to the position (b), the controller 180 may output a plurality of vibrations in which an amplitude is decreased or a period is increased. For example, when movement speed of the guider is 2 km/h at position (b) and movement speed of the user of the watch-type mobile terminal 100 is 3 km/h at position (b), a plurality of vibrations, in which an amplitude is decreased or a period is increased, may be output.

Meanwhile, movement speed of a user located at a specific position of a plurality of positions included in the exercise guide is equal to movement speed of a guider corresponding to the specific position, the controller may not output a tactile signal.

For example, when movement speed of the guider is 3 km/h at position (c) of the plurality of positions included in the exercise guide and movement speed of the user of the watch-type mobile terminal 100 is 3 km/h at position (c), the controller 180 may stop output of a tactile signal.

On the other hand, a range of error that can be predicted from the standpoint of a person skilled in the art can be regarded as being the same.

Meanwhile, an operating method will be described when information on a plurality of paces respectively corresponding to a plurality of positions included in an exercise guide is information on the number of walks per unit time corresponding to each of the plurality of positions.

When an exercise guide includes information on a plurality of positions and information on the number of walks per unit time corresponding to each of the plurality of positions, the controller 180 may output a tactile signal for guiding a user located at a specific position of the plurality of positions included in the exercise guide to exercise in the number of walks per unit time of a guider corresponding to the specific position.

For example, when the number of walks per unit time of the guider is 30 times/min at position (b) of the plurality of positions included in the exercise guide, the controller 180 may output a tactical signal for guiding a user located position (b) of the plurality of positions included in the exercise guide to exercise in the number of walks per unit time (30 times/min) corresponding to position (b).

In this case, the controller 180 may output a plurality of vibrations in the number of vibrations per unit time corresponding to the number of walks per unit time of the guider based on the number of walks per unit time of the guider corresponding to the specific position.

For example, when the number of walks per unit time of the guider is 30 times/min at position (b), the controller 180 may a plurality of vibrations in the number of vibrations per unit time (30 times/min) corresponding to the number of walks per unit time (30 times/min) of the guider.

Here, the plurality of vibrations may be output when the number of walks per unit time of the user at a specific point does not match the number of walks per unit time of the guider corresponding to the specific point. Specifically, the controller 180 may acquire information on the number of walks per unit time of the user at position (b) through the sensing unit 140. When the number of walks per unit time of the user at position (b) is different from the number of walks per unit time of the guider corresponding to position (b), the controller 180 may output a plurality of vibrations.

For example, when the number of walks per unit time of the guider is 80 times/min at position (b) and the number of walks per unit time of the user of the watch-type mobile terminal 100 is 80 times/min at position (b), the controller 180 may not output a tactical signal. When the number of walks per unit time of the guider is 30 times/min at position (b) and the number of walks per unit time of the user is not 30 times/min at position (b), the controller 180 may output a plurality of vibrations (30 times/min) corresponding to the number of walks per unit time based on the number of walks per unit time (30 times/min) corresponding to position (b).

Meanwhile, when the number of walks per unit time of the user at a specific position of a plurality of positions included in an exercise guide is equal to the number of walks per unit time of the guider corresponding to the specific point, the controller 180 may not output a tactical signal.

For example, when the number of walks per unit time of the guider is 50 times/min at position (c) of the plurality of positions included in the exercise guide and the number of walks per unit time of the user of the watch-type mobile terminal 100 is 50 times/min at position (c), the controller 180 may stop output of a tactical signal.

Meanwhile, an operating method will be described when information on a plurality of paces respectively corresponding to a plurality of positions included in an exercise guide is information on steps of a guider in a plurality of courses respectively corresponding to the plurality of positions.

When an exercise guide includes information on a plurality of positions and information on steps of a guider in a plurality of courses respectively corresponding to the plurality of positions and a user is located at a specific position of the plurality of positions, the controller 180 may output a tactical signal corresponding to steps of the guider in a course corresponding to the specific position.

For example, when a course corresponding to position (a) included in an exercise guide is a course from position (a) to position (b) and the user is located at position (a), the controller 180 may output vibrations corresponding to steps of the guider between position (a) and position (b).

In another example, when the course corresponding to position (b) included in the exercise guide is a course from position (b) to position (c) and the user is located position (b), the controller 180 may output vibrations corresponding to steps of the guider between position (b) and position (c).

Meanwhile, the controller 180 may output information on steps of the user through the sensing unit 140 and may output vibrations when steps of the guider do not match steps of the user.

For example, when steps of the user match steps of the guider until the user reaches a specific point between position (b) and position (c) through position (b), the controller 180 may not output vibrations until the user reaches the specific point between position (b) and position (c) through position (b). When steps of the user do not match steps of the guider until the user reaches the specific point between position (b) and position (c), the controller 180 may output vibrations until the user reaches position (c) from the specific point between position (b) and position (c).

The controller 180 may determine whether steps of the guider match steps of the user. On the other hand, times and ways to perform steps according to vibration are different according to users, when a step period of the guider matches a step period of the user, the controller 180 may determine that the steps of the guider match the steps of the user.

FIG. 5C is a graph showing a tactile signal output in a mobile terminal of a user while the user passes through position (c) from position (a) when information on a plurality of paces respectively corresponding to a plurality of positions included in an exercise guide is information on the number of walks per unit time corresponding to each of the plurality of positions.

The controller 180 may output a tactile signal for guiding a user located at a specific position of the plurality of positions included in the exercise guide to exercise in the number of walks per unit time of a guider corresponding to the specific position.

Specifically, the controller 180 may output a plurality of vibrations in the number of vibrations per unit time corresponding to the number of walks per unit time of the guider based on the number of walks per unit time of the guider corresponding to the specific poison.

For example, when the number of walks per unit time corresponding to each of the plurality of positions included in the exercise guide is 0 times/min at position (a), 50 times/min at position (b), and 50 times/min at position (c), the controller 180 may output vibrations in the number of vibrations per unit time (0 times/min) when a user is located at position (a), the number of vibrations per unit time (50 times/min) after the user passes position (b), and the number of vibrations per unit time (50 times/min) after the user passes through position (c). Meanwhile, in the present embodiment, it has been described that the exercise guide only includes position information at position (a), position (b), and position (c), and information on exercises paces corresponding to the positions, but the number of pieces of position information and information on exercise paces corresponding to the positions is not limited. For example, the exercise guide may include 100 pieces of position information from position (a) to position (c) and information on the number of walks per unit time corresponding to each of the 100 pieces of position information.

Meanwhile, when the number of walks per unit time of the guider is increased while the guide moves, a walk period of the guider is gradually decreased. In this case, the number of vibrations per unit time of vibration output in the watch-type mobile terminal 100 is gradually increased. That is, as illustrated in FIG. 5C, the controller 180 may output vibrations having a period which is gradually decreased.

On the other hand, in the present embodiment, it has been described that a plurality of vibrations have the same amplitude (strength of vibration), but the present disclosure is not limited thereto. For example, as a difference is increased between the number of walks per unit time of a user located at a specific position included in the exercise guide and the number of walks per unit time of a guider corresponding to the specific position included in the exercise guide, the controller 180 may increase and output an amplitude (strength of vibration) of a plurality of vibrations.

FIG. 5D is a graph showing a tactile signal output in a mobile terminal of a user passing through position (c) from position (a) when information on a plurality of paces respectively corresponding to a plurality of positions included in an exercise guide is information on movement speeds respectively corresponding to the plurality of positions.

The controller 180 may output a tactile signal for guiding a user located at a specific position of the plurality of positions included in the exercise guide to exercise at movement speed of a guider corresponding to the specific position.

Specifically, when movement speed of the user at a specific position is greater than movement speed of the guider corresponding to the specific position, a plurality of vibrations 511, 512, 513, 514, and 515, in which an amplitude is decreased or a period is increased, may be output based on the specific position included in the exercise guide, movement speed of the guider corresponding to the specific position, and a current position and current movement speed of the user.

For example, when movement speeds of the guider respectively corresponding to the plurality of positions included in the exercise guide are 0 km/h at position (a), 2 km/h at position (b), and 3 km/h at position (c) and the user moves at speed greater than movement speed of the guider as illustrated in FIG. 5B, as illustrated in FIG. 5D, the controller 180 may output the plurality of vibrations 511, 512, 513, 514, and 515, in which the amplitude is decreased or the period is increased.

Meanwhile, the plurality of vibrations 511, 512, 513, 514, and 515, in which the amplitude is decreased or the period is increased, may constitute one vibration set 510, the controller 180 may output a plurality of vibration sets 510, 520, and 530 according to a certain period.

However, the present disclosure is not limited thereto, and the plurality of vibration sets 510, 520, and 530 may be output at different periods depending on the situation. Specifically, as a difference is increased between movement speed of the user located at a specific position included in an exercise guide and movement speed corresponding to the specific position included in the exercise guide, the controller 180 may output the plurality of vibration sets 510, 520, and 530 at a short period. For example, when an output period of a plurality of vibrations is assumed to be a first period in a case in which movement speed when the guider passes through position (b) is 2 km/h and movement speed when the user passes through position (b) is 5 km/h and an output period of the plurality of vibrations is assumed to be a second period in a case in which movement speed when the guider passes through position (c) is 3 km/h and movement speed when the user passes through position (c) is 3.5 km/h, the first period may be less than the second period.

In another example, as a difference is increased between movement speed of a user located at a specific position included in an exercise guide and movement speed corresponding to the specific position included in the exercise guide, the controller 180 may output the plurality of vibrations 511, 512, 513, 514, and 515 by increasing a difference between amplitudes (strengths of vibration) thereof.

Meanwhile, in the present embodiment, it has been described that an exercise is guided by using position information at position (a), position (b), and position (c), and information on exercises paces corresponding to the positions. However, the present disclosure is not limited thereto, and an exercise of a user may be guided by using position information at more positions and information on paces corresponding to the positions. As position information usable in the same course and information on paces corresponding thereto are further increased, an exercise of a user may be guided so as to further match an actual exercise state of a guider.

For example, when an exercise guide only includes position information at position (a), position (b), and position (c), and information on exercises paces corresponding to the positions, the controller 180 outputs vibrations in the number of vibrations per unit time (0 times/min) when a user moves from position (a) to position (b), and the number of vibrations per unit time (30 times/min) when the user moves to position (c) through position (b). When an exercise guide includes 10 pieces of information at positions (for example, a first position, a second position, a third position, a fourth position, a fifth position, a sixth position, a seventh position, an eighth position, a ninth position, and a tenth position) and information on paces (0 times/min, 5 times/min, 10 times/min, 15 times/min, 20 times/min, 25 times/min, 30 times/min, 35 times/min, 40 times/min, and 45 times/min), the controller 180 may output vibration in the number of vibrations per unit time (0 times/min) when a user moves from the first position to the second position, vibration in the number of vibrations per unit time (5 times/min) when the user moves from the second position to the third position, vibration in the number of vibrations per unit time (10 times/min) when the user moves from the third position to the fourth position, and vibration in the number of vibrations per unit time (15 times/min) when the user moves from the fourth position to the fifth position. Accordingly, an exercise of the user may be guided so as to further match an actual exercise state of the guider.

Meanwhile, the controller 180 may acquire information on a pace at a specific position between a plurality of positions included in an exercise guide based on information on the plurality of positions and information on paces corresponding to the information on the plurality of positions, and may guide an exercise pace of the user by using the acquired information on the pace at the specific position.

For example, when the number of walks per unit time of the guider is 0 times/min at position (a) and is 30 times/min at position (b), the controller 180 may estimate that the number of walks per unit time is 15 times/min at position (z) which is an intermediate position between position (a) and position (b). When the user passes through position (z) which is an intermediate position between position (a) and position (b), the controller 180 may output vibration in the number of vibrations per unit time (15 times/min). Therefore, an exercise of the user may be guided so as to further match an actual exercise state of the guider.

FIG. 5E is a diagram illustrating a tactile signal output in a mobile terminal of a user while the user passes through position (c) from position (a) when information on a plurality of paces respectively corresponding to a plurality of positions is information on steps of a guider in courses respectively corresponding to the plurality of positions.

When the user is located at a specific position of a plurality of positions included in an exercise guide, the controller 180 may output a signal corresponding to steps of the guider in a course corresponding to the specific position.

For example, when the user is located at position (a) and a course corresponding to position (a) is a course from position (a) to position (c), the controller 180 may output vibrations corresponding to steps of the guider from position (a) to position (c).

Meanwhile, since the guider increases speed while moving from position (a) to position (c), as illustrated in FIG. 5E, a period between steps of the guider is gradually decreased. Therefore, as illustrated in FIG. 5E, vibrations output in the mobile terminal 100 may be output such that a period between the vibrations is gradually decreased.

On the other hand, in the present embodiment, it has been described that a plurality of vibrations have the same amplitude (strength of vibration), but the present disclosure is not limited thereto. That is, as a difference is increased between steps of a guider and steps of a user, the controller 180 may output vibrations by increasing strength of the vibrations. For example, as a difference is increased between steps of the guider and steps of the user, the controller 180 may output vibrations by increasing strength of the vibrations.

Meanwhile, the controller 180 may control the output unit 150 to output a tactile signal.

On the other hand, it has been described that a tactile signal is vibration, the present disclosure is not limited thereto. For example, a tactile signal may be a signal capable of generating various tactile effects such as an effect according to an arrangement of pins vertically moving against a contact skin surface, an effect according to a jet force or suction force of air through a jet hole or a suction hole, an effect of rubbing the skin, an effect according to contact of an electrode, an effect according to an electrostatic force, and an effect according to a reproduction of cold and warmth using an element capable of absorbing or radiating heat. In addition, a tactile signal may be a signal capable of allowing a user to feel a tactile effect through a kinesthetic sense of the user's fingers or arms.

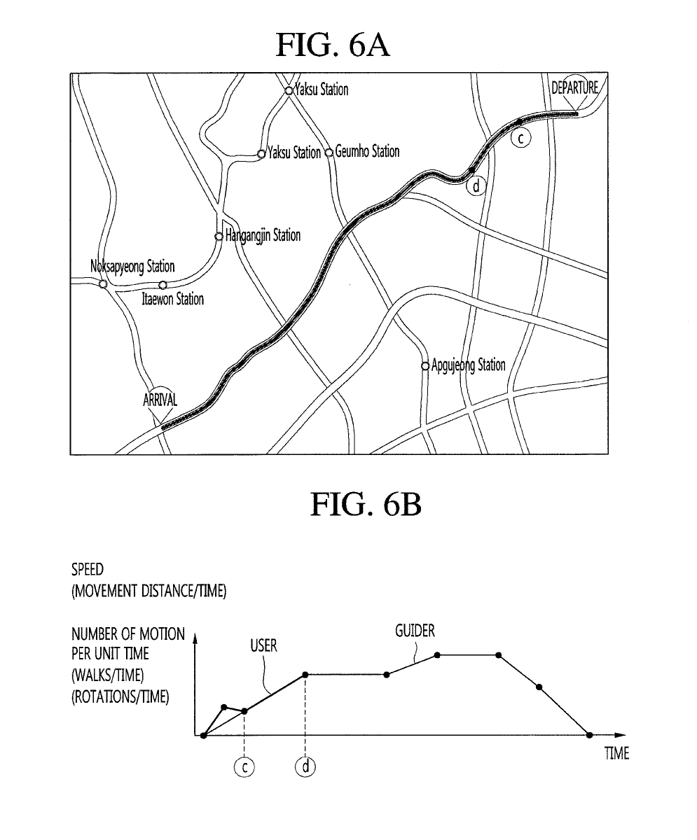

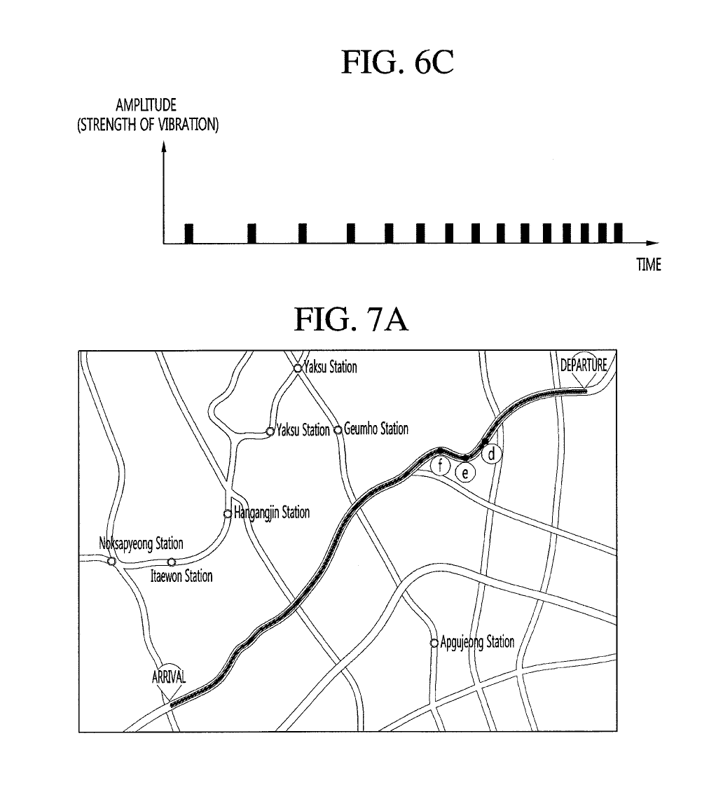

Position (c) to position (d) of FIGS. 6A and 6B is a course in which a guider gradually increases an exercise pace, and a user also increases an exercise pace such that the exercise pace matches the exercise pace of the guider.

A case in which information on a plurality of paces of the guider respectively corresponding to a plurality of positions included in an exercise guide is information on movement speeds respectively corresponding to the plurality of positions will be described.

Since movement speed of the guider from position (c) to position (d) is equal to movement speed of the user from position (c) to position (d), a tactile signal may not be output.

Specifically, when movement speed of the guider is 3 km/h at position (c) and movement speed of the user of the watch-type mobile terminal 100 is 3 km/h at position (c), the controller 180 may stop output of a tactile signal. In addition, when movement speed of the guider is 3.5 km/h at a specific point between position (c) and position (d) and movement speed of the user of the watch-type mobile terminal 100 is 3.5 km/h at the specific point between position (c) and position (d), the controller 180 may not output a tactile signal. The controller 180 may output a tactile signal from position (d) at which movement speed of the guider is different from movement speed of the user.

A case in which information on a plurality of paces respectively corresponding to a plurality of positions included in an exercise guide is information on the number of walks per unit time corresponding to each of the plurality of positions will be described.

Since the number of walks per unit time of the guider from position (c) to position (d) is equal to the number of walks per unit time of the user from position (c) to position (d), a tactile signal may not be output.

Specifically, when the number of walks per unit time of the guider is 30 times/min at position (c) and the number of walks per unit time of the user of the watch-type mobile terminal 100 is 30 times/min at position (c), the controller 180 may stop output of a tactical signal. In addition, when the number of walks per unit time of the guider is 50 times/min at a certain point between position (c) and position (d) and the number of walks per unit time of the user of the watch-type mobile terminal 100 is 50 times/min at the specific point, the controller 180 may not output a tactical signal. The controller 180 may output a tactile signal from position (d) at which the number of walks per unit time of the guider is different from the number of walks per unit time of the user.

However, the present disclosure is not limited thereto. For example, as illustrated in FIG. 6C, the controller 180 may output a plurality of vibrations in the number of vibrations per unit time corresponding to the number of walks per unit time of the guider regardless of a match between the number of walks per unit time of the guider and the number of walks per unit time of the user.

In this case, since the number of walks per unit time of the guider is gradually increased, the number of vibrations per unit time of a plurality of vibrations output in the watch-type mobile terminal 100 may be increased (i.e., a vibration period may be decreased).

Meanwhile, an operating method will be described when information on a plurality of paces respectively corresponding to a plurality of positions included in an exercise guide is information on steps of a guider in a plurality of courses respectively corresponding to the plurality of positions.

Since steps of the guider from position (c) to position (d) match steps of the user from position (c) to position (d), a tactile signal may not be output. However, the present disclosure is not limited thereto, and the controller 180 may output vibrations corresponding to steps of the guider regardless of a match between steps of the guider and steps of the user.

Meanwhile, since the guider increases movement speed while moving from position (c) to position (d), a period between steps of the guider may be gradually decreased. Accordingly, output vibrations may be output in the shape of FIG. 6C.

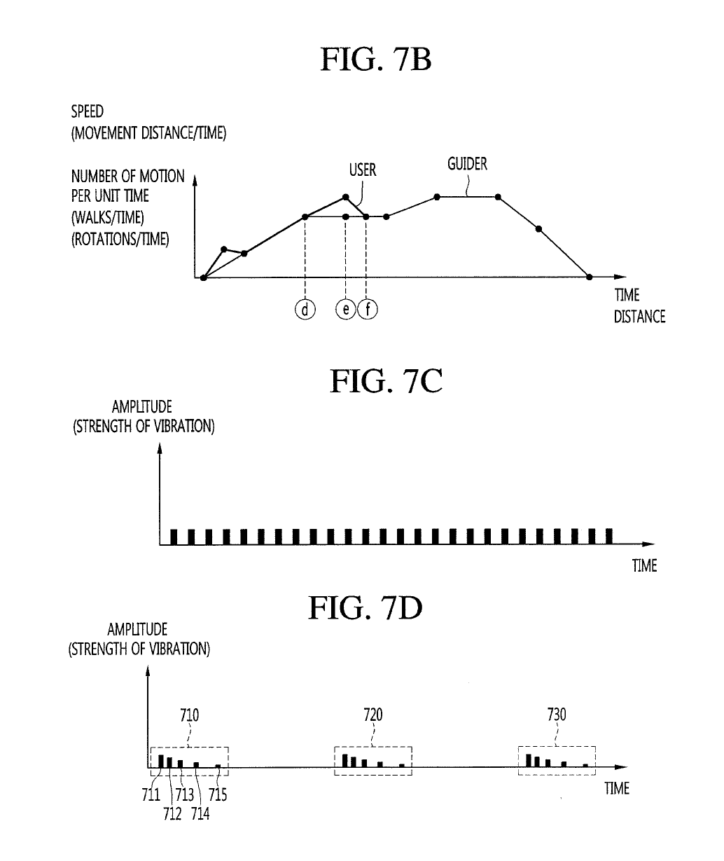

A course from position (d) to position (f) of FIGS. 7A and 7B is a course in which the guider maintains the same exercise pace, and the user continuously increases an exercise pace and then decreases the exercise pace at position (e) such that the exercise pace matches the exercise pace of the guider at position (f). Here, descriptions assume that position (d) is a position immediately after the exercise pace of the user is different from a pace corresponding to position (d) included in an exercise guide.

A case in which information on a plurality of paces respectively corresponding to a plurality of positions included in an exercise guide is information on the number of walks per unit time corresponding to each of the plurality of positions will be described.

The controller 180 may determine that the number of walks per unit time corresponding to position (d) of a plurality of positions included in an exercise guide does not match the number of walks per unit time of the user at position (d). The controller 180 may output a plurality of vibrations in the number of vibrations per unit time corresponding to the number of motions per unit time of the guider at position (d) until the user reaches position (e).

In addition, the controller 180 may determine that the number of walks per unit time of the guider corresponding to position (e) of a plurality of positions included in an exercise guide does not match the number of walks per unit time of the user at position (e). The controller 180 may output a plurality of vibrations corresponding to the number of motions per unit time of the guider at position (e) until the user reaches position (f).

In this case, vibrations output in the watch-type mobile terminal 100 are illustrated in FIG. 7C. Since the guider moves in the same number of walks per unit from position (d) to position (f), the numbers of walks per unit respectively corresponding to positions (d), (e), and (f) are the same. Thus, the controller 180 may output a plurality of vibrations having the same period.

Meanwhile, it has been described that as a difference is increased between the number of walks per unit time of the user located at a specific position included in an exercise guide and the number of walks per unit time of the guider corresponding to the specific position, strength of vibration is increased. For example, while the user moves from position (d) to position (e), strength of vibration output in the watch-type mobile terminal 100 may be gradually increased. While the user moves from position (e) to position (f), strength of vibration output in the watch-type mobile terminal 100 may be gradually decreased.

Meanwhile, an operating method will be described when information on a plurality of paces respectively corresponding to a plurality of positions included in an exercise guide is information on steps of the guider in a plurality of courses respectively corresponding to the plurality of positions.

When the user is located at position (d) and then moves to position (f), the controller 180 may output vibrations corresponding to steps of the guider in a course between position (d) and position (f).

Meanwhile, the controller 180 may determine that steps of the guider are different from steps of the user immediately after the user is located at position (d).

In this case, the controller 180 may output vibrations corresponding to steps of the guider immediately after the user is located at position (d). In addition, the controller 180 may continuously output vibrations until the user reaches position (f) at which steps of the guider match steps of the user. On the other hand, the guider maintains the same step period from position (d) to position (f), and vibrations output in the watch-type mobile terminal may be output as in FIG. 7C.

Meanwhile, a case in which information on a plurality of paces respectively corresponding to a plurality of positions included in an exercise guide is information on movement speeds respectively corresponding to the plurality of positions will be described.

The controller 180 may determine that movement speed of the guider corresponding to position (d) of information on a plurality of positions included in an exercise guide is less than movement speed of the user at position (d).

In addition, the controller 180 may determine that movement speed of the guider corresponding to position (e) of the information on the plurality of positions included in the exercise guide is less than movement speed of the user at position (e).

In this case, as illustrated in FIG. 7D, the controller 180 may output a plurality of vibrations 711, 712, 713, 714, and 715 in which an amplitude is decreased or a period is increased. In addition, the controller 180 may output a plurality of vibration sets 710, m720, and 730 until the user reaches position (f) from a time when the user is located at position (d).

Meanwhile, as a difference is increased between movement speed of the user located at a specific position included in an exercise guide and movement speed corresponding to the specific position included in the exercise guide, the controller 180 may output the plurality of vibration sets 710, 720, and 730 at a short period. For example, while the user moves from position (d) to position (e), an output period of the vibration sets 710, 720, and 730 output in the watch-type mobile terminal 100 may be gradually decreased. While the user moves from position (e) to position (f), an output period of the vibration sets 710, 720, and 730 output in the watch-type mobile terminal 100 may be gradually increased.

In addition, as a difference is increased between movement speed of the user located at the specific position included in the exercise guide and movement speed corresponding to the specific position included in the exercise guide, a difference between amplitudes of the plurality of vibrations 711, 712, 713, 714, and 715 may be increased as described above. For example, while the user moves from position (d) to position (e), the difference between the amplitudes of the plurality of vibrations 711, 712, 713, 714, and 715 output in the watch-type mobile terminal 100 may be gradually increased. While the user moves from position (e) to position (f), the difference between the amplitudes of the plurality of vibrations 711, 712, 713, 714, and 715 output in the watch-type mobile terminal 100 may be gradually decreased.

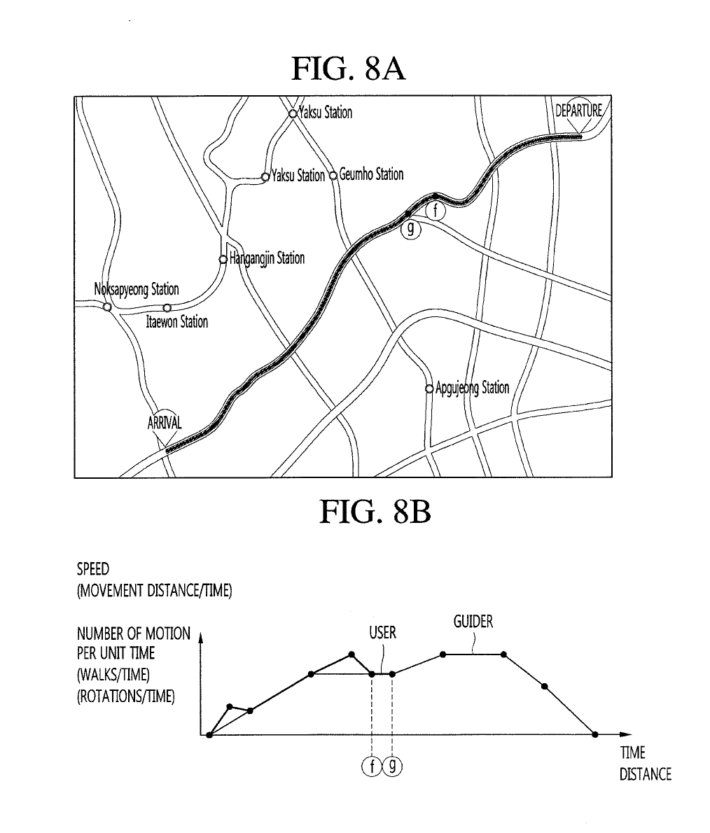

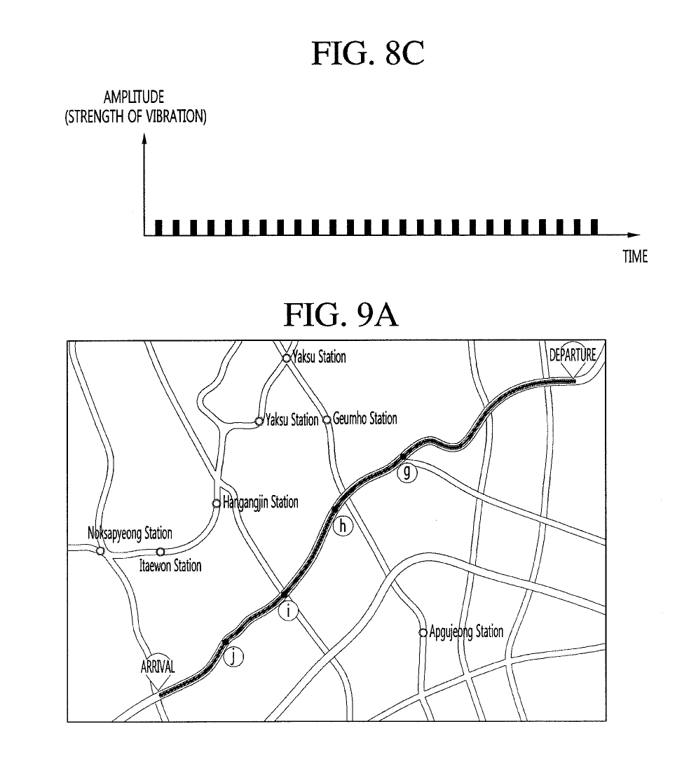

A course from position (f) and to position (g) of FIGS. 8A and 8B is a course in which the guider maintains the same exercise pace and the user exercises at the same exercise pace as the guider. Descriptions assume that position (f) is a position at which an exercise pace of the user matches an exercise pace of the guider.

A case in which information on a plurality of paces respectively corresponding to a plurality of positions included in an exercise guide is information on the number of walks per unit time of the guider corresponding to each of the plurality of positions will be described.

The controller 180 determine that the number of walks per unit time of the guider corresponding to position (f) of information on a plurality of positions included in an exercise guide matches the number of walks per unit time of the user at position (f).

In this case, after the controller 180 stops output of vibrations, the controller 180 may start to output vibrations from position (g) at which the number of walks per unit time of the user is different from the number of walks per unit time of the guider.

However, the present disclosure is not limited thereto. For example, as illustrated in FIG. 8C, the controller 180 may output a plurality of vibrations in the number of vibrations per unit time corresponding to the number of walks per unit time of the guider regardless of a match between the number of walks per unit time of the guider and the number of walks per unit time of the user.

In this case, the guider maintains the same number of walks per unit time from position (f) to position (g), and vibrations output in the watch-type mobile terminal 100 may be output in the same period.

Meanwhile, an operating method will be described when information on a plurality of paces respectively corresponding to a plurality of positions included in an exercise guide is information on steps of the guider in a plurality of courses respectively corresponding to the plurality of positions.

The controller 180 may determine that steps of the guider in a course between position (f) and position (g) match steps of the user in the course between position (f) and position (g).

In this case, after the controller stops output of vibrations at position (f), the controller 180 may start to output vibrations from position (g) at which steps of the user are different from steps of the guider.

Even when steps of the guider match steps of the user, vibrations may be continuously output. In this case, a step period of the guider is constant, and vibrations output in the watch-type mobile terminal 100 may be output in a constant period as illustrated in FIG. 8C.

Meanwhile, when a stride of the guider is different from a step of the user, although the user walks so as to correspond to steps of the guider, actual movement distances may be different.

Therefore, the controller 180 may correct information on steps of the guider and may output a tactile signal corresponding to the steps of the guider based on the corrected information on the steps of the guider.

Specifically, an exercise guide may include information on a stride of the guider. Meanwhile, the controller 180 may acquire information on a stride of the user. For example, the controller 180 may acquire information on a stride of the user based on a user input through the input unit 120. In another example, information on a stride of the user may be acquired by using a movement distance per unit time and information on the number of walks per unit time of the user. On the other hand, information on a stride of the guider may be information acquired in the same manner.

The controller 180 may correct information on steps of the guider by using information on a stride of the guider included in an exercise guide, information on steps of the guider, and information on a stride of the user included in exercise information of the user. In this case, a correction reference of information on steps may be based on a case in which a movement distance of the guider for a specific time is equal to a movement distance of the user for a specific time.

For example, when a stride of the guider is 50 cm and the guider takes 1,000 steps and a stride of the user is 60 cm, although the user takes only 833 steps, the user may move the same distance as a distance in which the guider moves. Therefore, while the user located at position (f) moves to position(g), the controller 180 may output 833 vibrations rather than 1,000 vibrations.

In addition, before correction, 1,000 vibrations should be output for a specific time, and after the correction, 833 vibrations should be output for the specific time, so that an output period between vibrations may also be corrected and output.

Meanwhile, a case in which information on a plurality of paces respectively corresponding to a plurality of positions included in an exercise guide is information on movement speeds respectively corresponding to the plurality of positions will be described.

The controller 180 may determine that movement speed of the guider corresponding to position (f) of information on a plurality of positions included in an exercise guide matches movement speed of the user at position (f).

In this case, after the controller 180 stops output of vibrations at position (f), the controller 180 may start to output vibrations from position (g) at which movement speed of the guider is different from movement speed of the user.

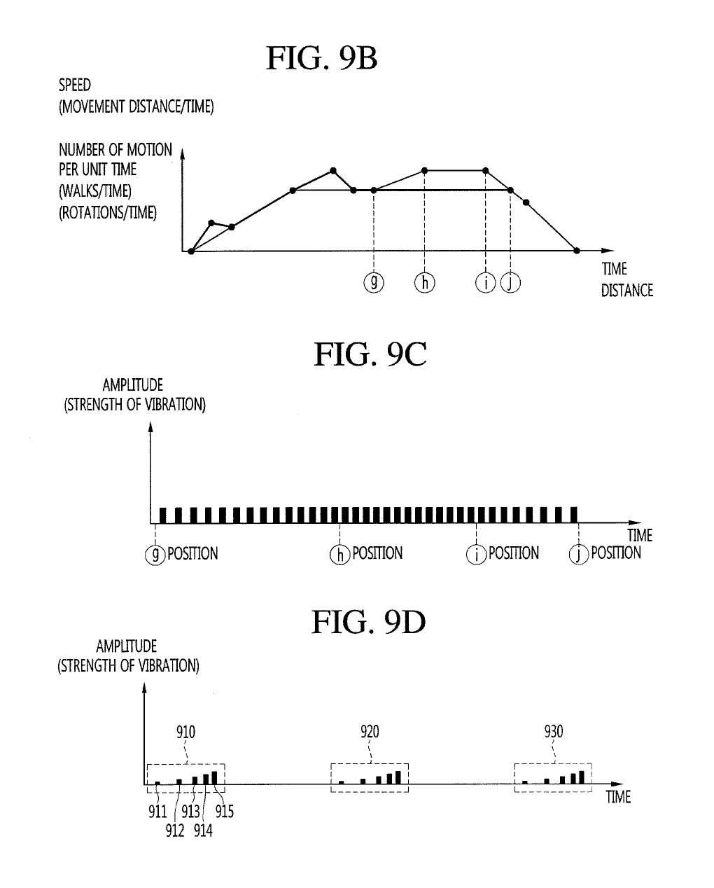

A course from position (g) to position (j) of FIGS. 9A and 9B is a course in which the guider increases an exercise pace to maintain the same exercise pace and then decreases the exercise pace and the user exercises at the same exercise pace regardless of the exercise pace of the guider. Descriptions assume that position (g) is a position at which an exercise pace of the user is different from an exercise pace of the guider corresponding to position (g) included in an exercise guide.

A case in which information on a plurality of paces of the guider respectively corresponding to a plurality of positions included in an exercise guide is information on the number of walks per unit time corresponding to each of the plurality of positions will be described.

The controller 180 may determine that the number of walks per unit time of the guider corresponding to position (g) of information on a plurality of positions included in an exercise guide does not match the number of walks per unit time of the user at position (g). The controller 180 may output a plurality of vibrations in the number of vibrations per unit time corresponding to the number of motions per unit time of the guider at position (g).

In addition, the controller 180 may determine that the number of walks per unit time of the guider corresponding to position (h) of information on a plurality of positions included in an exercise guide does not match the number of walks per unit time of the user at position (h). The controller 180 may output a plurality of vibrations in the number of vibrations per unit time corresponding to the number of motions per unit time of the guider at position (h).

Meanwhile, as described above, an exercise guide may include position information at position (g) and position (h) and information on paces corresponding to the positions as well as information on a plurality of positions between position (g) and position (h) and information on paces corresponding to the positions.

In addition, as described above, the controller 180 may calculate information on a pace at a specific position between position (g) and position (h) by using the position information at position (g) and position (h) and the information on paces corresponding to the positions.

Meanwhile, the guider gradually increases the number of motions per unit time from position (g) to position (h), and the number of vibrations per unit of a plurality of vibrations output while the user moves from position (g) to position (h) may also be increased (i.e., a vibration period may be decreased).

On the other hand, when the user moves from position (h) to position (i), the number of walks per unit time of the guider from position (h) to position (i) is different from the number of walks per unit time of the user from position (h) to position (i). Accordingly, the controller 180 may output a plurality of vibrations in the number of vibrations per unit time corresponding to the number of walks per unit time of the guider from position (h) to position (i).

In this case, the plurality of vibrations output while the user moves from position (h) to position (i) may be output as illustrated in FIG. 9C. That is, the number of walks per unit time of the guider from position (h) to position (i) is constant, the controller 180 may output vibrations in the same number of vibrations per unit time while the user moves from position (h) to position (i) (i.e., a vibration period may be constant).

Meanwhile, the controller 180 may determine that the number of walks per unit time of the guider corresponding to position (i) of information on a plurality of positions included in an exercise guide does not match the number of walks per unit time of the user at position (i).

In addition, the controller 180 may determine that the number of walks per unit time of the guider corresponding to position (j) of information on a plurality of positions included in an exercise guide matches the number of walks per unit time of the user at position (j).

In this case, while the user moves from position (i) to position (j), as illustrated in FIG. 9C, the controller 180 may output a plurality of vibrations in the number of vibrations per unit time corresponding to the number of walks per unit time of the guider from position (i) to position (j).

In this case, the number of walks per unit time of the guider is gradually decreased from position (i) to position (j), and while the user moves from position (i) to position (j), the controller 180 may output a plurality of vibrations in which the number of vibrations per unit time is gradually decreased (i.e., a vibration period is increased).

Meanwhile, an operating method will be described when information on a plurality of paces respectively corresponding to a plurality of positions included in an exercise guide is information on steps of the guider in a plurality of courses respectively corresponding to the plurality of positions.

Since steps of the user from position (g) to position (j) are different from steps of the guider from position (g) to position (j), the controller 180 may output vibrations corresponding to the steps of the guider.

On the other hand, a step period of the guider is gradually decreased and is maintained as a certain value and then is increased, and vibration output in the watch-type mobile terminal may also be output in the form of FIG. 9C.

Meanwhile, a case in which information on a plurality of paces respectively corresponding to a plurality of positions included in an exercise guide is information on movement speeds respectively corresponding to the plurality of positions will be described.

The controller 180 may determine that movement speed of the guider corresponding to position (g) of a plurality of positions included in an exercise guide does not match a movement speed of the user at position (g).

The controller 180 may determine that movement speed of the guider between position (g) and position (j) is greater than movement speed of the user between position (g) and position (j).

Meanwhile, when movement speed of the user at a specific position of a plurality of positions included in an exercise guide is less than movement speed of the guider corresponding to the specific position of the plurality of positions, the controller 180 may output a plurality of vibrations in which an amplitude is increased or a period is decreased.

For example, while the user moves from position (g) to position (j), movement speed of the guider is greater than movement speed of the user. Accordingly, as illustrated in FIG. 9D, the controller 180 may output a plurality of vibrations 911, 912, 913, 914, and 915 in which an amplitude is increased or a period is decreased. In addition, while the user moves from position (g) to position (j), the controller 180 may output a plurality of vibration sets 910, 920, and 930.

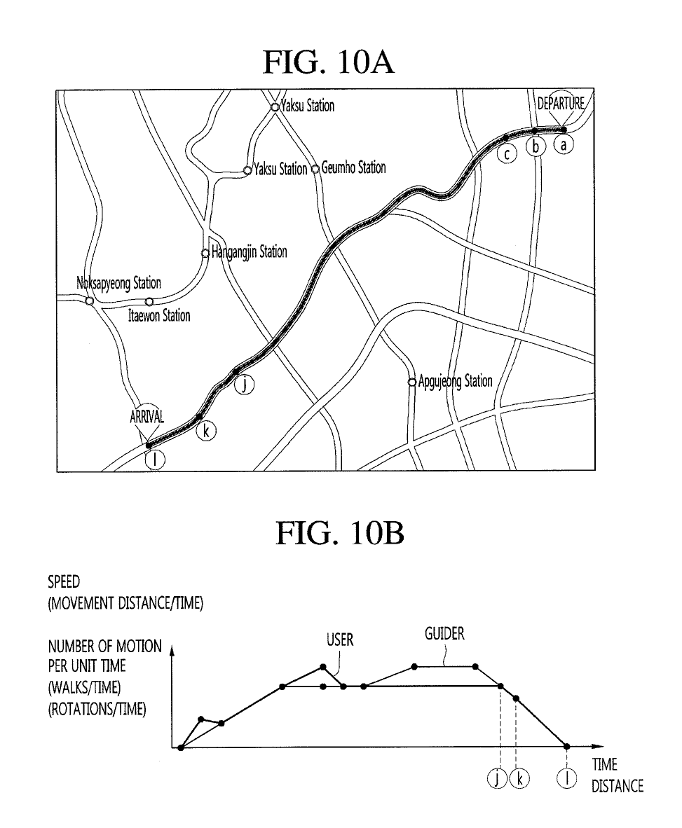

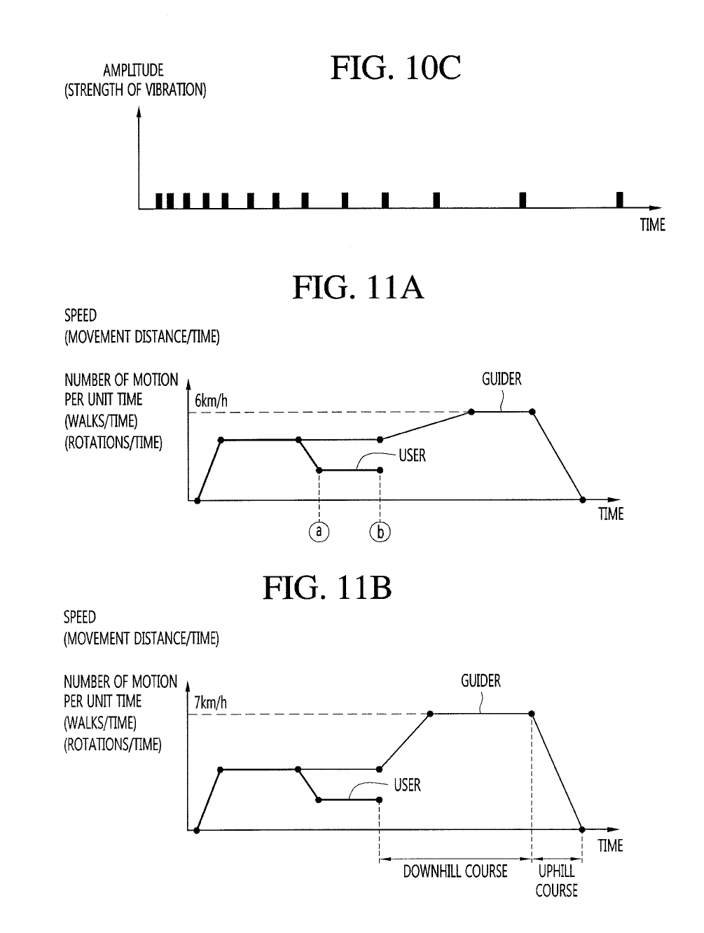

A course from position (j) to position (1) of FIGS. 10A and 10B is a course in which the guider decreases an exercise pace and a user decreases an exercise pace such that the exercise pace corresponds to the exercise pace of the guider.

An operating method will be described when information on a plurality of paces respectively corresponding to a plurality of positions included in an exercise guide is information on movement speeds respectively corresponding to the plurality of positions.

Movement speed of the user at position (j), position (1), and a specific position between position (j) and position (1) is equal to movement speed of the guider at position (j), position (1), and the specific position between position (j) and position (1). Therefore, the controller 180 may stop output of a tactile signal when the user is located at position (j) and may not output a tactile signal while the user moves from position (j) to position (1).

Meanwhile, an operating method will be described when information on a plurality of paces respectively corresponding to a plurality of positions included in an exercise guide is information on the number of walks per unit time corresponding to the plurality of paces.

The number of walks per unit time of the guider at position (j), position (1), and the specific position between position (j) and position (1) is equal to the number of walks per unit time of the user at position (j), position (1), and the specific position between position (j) and position (1). Therefore, the controller 180 may stop output of a tactile signal when the user is located at position (j) and may not output a tactile signal while the user moves from position (j) to position (1).

However, the present disclosure is not limited thereto. For example, as illustrated in FIG. 10C, the controller 180 may output a plurality of vibrations in the number of vibrations per unit time corresponding to the number of walks per unit time of the guider regardless of a match between the number of walks per unit time of the guider and the number of walks per unit time of the user.

In this case, since the number of walks per unit time of the guider is gradually increased while the guider moves from (j) to position (1), while the user moves from (j) to position (1), as illustrated in FIG. 10C, the watch-type mobile terminal 100 may output a plurality of vibrations in which the number of vibrations per unit time is decreased (i.e., a period is increased).

Meanwhile, an operating method will be described when information on a plurality of paces respectively corresponding to a plurality of positions included in an exercise guide is information on steps of the guider in a plurality of courses respectively corresponding to the plurality of positions.

Since steps of the guider from position (j) to position (1) match steps of the user from position (j) to position (1), a tactile signal may not be output. However, the present disclosure is not limited thereto, and the controller 180 may output vibrations corresponding to steps of the guider regardless of a match between steps of the guider and steps of the user.

On the other hand, since the guider decreases movement speed while moving from position (j) to position (1), a period between steps of the guider is gradually increased. Accordingly, output vibrations may be output in the form of FIG. 10C.

Meanwhile, in FIGS. 5 to 10, it has been described that the number of motions per unit time is the number of walks per unit time, but the present disclosure is not limited thereto. For example, when the user exercises using a bicycle, the number of motions per unit time may be the number of rotations per unit time of a pedal of the bicycle.

As described above, according to the present disclosure, it is possible to share sketchy information on exercise records such as a distance for each course, an elapsed time for each course, and the like as well as exercise paces at a plurality of positions during an exercise, thereby guiding an exercise of a user based on a more accurate exercise pace.

In addition, since an exercise guide is output in the form of a tactile signal, the present disclosure may provide an environment in which a user who is absorbed in an exercise exercises according to the exercise guide without even watching a watch-type mobile terminal.

For example, when a user needs to change movement speed, a tactile signal for changing movement signal may be transferred to the user. Accordingly, the user may exercise according to an exercise guide without even watching a mobile terminal.

In addition, when a user needs to exercise in the number of motions per specific unit time, a tactile signal may be output in the number of vibrations per specific unit time. Accordingly, the user may exercise according to an exercise guide without even watching a mobile terminal. For example, when a first vibration is output, a user may take a first step, when a second vibration is output, the user may take a second step, and when a third vibration is output, the user may take a third step.

Meanwhile, in FIGS. 5 to 10, it has been described that an exercise of a user is guided by using information on a plurality of positions included in an exercise guide and information on a plurality of exercise paces respectively corresponding to the plurality of positions, but the present disclosure is not limited thereto.

That is, the watch-type mobile terminal 100 may guide an exercise of a user by using information on a plurality of times elapsed since a guider started to exercise and information on a plurality of exercise paces respectively corresponding to the plurality of times elapsed since the guider started to exercise, which are included in an exercise guide.

For example, an exercise guide may include a first time (for example, one minute) elapsed since a guider started to exercise and information on a pace (for example, 3 km/h) corresponding to the first time, and a second time (for example, 20 minutes) elapsed since the guider started to exercise and information on a pace (for example, 7 km/h) corresponding to the second time.

The controller 180 may output a tactile signal for guiding a user at a time when a specific time elapsed since the user started to exercise, to exercise at an exercise pace of a guider at a time when the specific time of a plurality of times included in the exercise guide has elapsed.

For example, when movement speed of a guider is 3 km/h at a time when a first time (for example, one minute) since the guider started to exercise and the first time (one minute) has been elapsed since a user started to exercise, the controller 180 may output a tactile signal for guiding the user to exercise at a movement speed of 3 km/h.

In another example, when movement speed of a guider is 7 km/h at a time when a second time (for example, 20 minutes) since the guider started to exercise and the second time (20 minutes) has been elapsed since a user started to exercise, the controller 180 may output a tactile signal for guiding the user to exercise at a movement speed of 7 km/h.

In addition, when a specific time has elapsed since a user started to exercise, the controller 180 may output a tactile signal corresponding to steps of a guider in a course corresponding to the specific time.

For example, when an exercise guide includes information on a first time elapsed since the guider started to exercise and information on steps of the guider in a course corresponding to the first time (for example, a course in which the guider moves from the first time and a second time), and information on the second time elapsed since the guider started to exercise and information on steps of the guider in a course corresponding to the second time, and the first time has elapsed since the user started to exercise, the controller 180 may output a tactile signal corresponding to steps of the guider in the course corresponding to the first time until the second time has elapsed since the user started to exercise.

In addition, the controller 180 may guide an exercise of the user by using information on a plurality of positions of the guider and information on exercise paces of the guider respectively corresponding to the plurality of positions, and information on a plurality of times elapsed since the guider started to exercise and information on a plurality of exercise paces respectively corresponding to the plurality of times elapsed since the guider started to exercise.

For example, when the guider spends a first time after starting to exercise and reaches a first position and the user doest not reach the first position despite spending the first time after starting to exercise, the controller 180 may guide an exercise of the user based on information on an exercise pace of the guider corresponding to the first position when the user reaches the first position.

In another example, when the guider spends a second time after starting to exercise and reaches a second position and the user spends a time less than the second time and reaches the second position, the controller 180 may guide an exercise of the user based on information on an exercise pace of the guider corresponding to the second position when the user reaches the second position.

Meanwhile, an exercise guide may include the first time, the second time, and information on exercise paces of the guider respectively corresponding to the first time and the second time as well as information on a plurality of times and information on exercise paces of the guider corresponding to the plurality of times, the watch-type mobile terminal 100 may guide an exercise of the user by using the information on the plurality of times and the information on the exercise paces of the guider respectively corresponding to the plurality of times.

When an exercise pace of the user is guided by using a time elapsed since an exercise started and information on a pace corresponding to the elapsed time, although a region in which the guider exercise is different from a region in which the user exercises, an exercise of the user may be guided based on an exercise pace of the guide.

For example, even when the guider exercises on main street A in Busan and the user exercises in park B in Seoul, the watch-type mobile terminal 100 may guide an exercise of the user based on an exercise pace of the guider.

In another example, when the guider exercises by using a cycle machine fixed to a specific position, the watch-type mobile terminal 100 may guide the user exercising by using the cycle machine to exercise by referring to an exercise pace of the guider.

In another example, when the guider exercises by using a cycle machine fixed to a specific position, the watch-type mobile terminal 100 may guide the user exercising by using an actual bicycle in park B in Seoul to exercise by referring to an exercise pace of the guider.

Meanwhile, the controller 180 may correct an exercise pace of the guider included in an exercise guide. Specifically, the controller 180 may correct information on exercise paces of the guider corresponding to information on a plurality of positions included in an exercise guide or may correct information on exercise paces of the guider corresponding to information of a plurality of times included in the exercise guide.

In this case, the controller 180 may correct the exercise paces of the guider included in the exercise guide based on weather information included in the exercise guide and weather information while the user exercises.

For example, when humidity when the user exercises is higher than humidity when the guider exercises, an exercise of the user may be more physically difficult than an exercise of the guider. In this case, the controller 180 may correct an exercise pace of the guider to an exercise pace having a lower level than the exercise pace based on humidity information included in the exercise guide and humidity information when the user exercises. The controller 180 may output a tactile signal for guiding an exercise pace of the user based on the corrected exercise pace of the guider.

In another example, when temperature when the user exercises is lower than temperature when the guider exercises, consumption of physical strength by an exercise of the user may be less than consumption of physical strength by an exercise of the guider. In this case, the controller 180 may correct an exercise pace of the guider to an exercise pace having a higher level than the exercise pace based on temperature information included in the exercise guide and temperature when the user exercises. The controller 180 may output a tactile signal for guiding an exercise pace of the user based on the corrected exercise pace of the guider.

On the other hand, the controller 180 may acquire weather information through sensing of the sensing unit 140. To this end, the sensing unit 140 may include at least of a humidity sensor and a temperature sensor. In addition, the controller 180 may acquire weather information by receiving a user input related to weather input through the input unit 120. Furthermore, the controller 180 may receive weather information of a region in which the user is located, from the outside through the wireless communication unit 110.

Meanwhile, weather information included in the exercise guide may also be acquired in the same manner.

In another example, the controller 180 may correct an exercise pace of the guider included in the exercise guide based on weight information of the guider included in the exercise guide and weight information of the user.

For example, when weight of the user is greater than weight of the guider, an exercise of the user may be more physically difficult than an exercise of the guider. In this case, the controller 180 may correct an exercise pace of the guider to an exercise pace having a lower level than the exercise pace based on the weight information of the guider included in the exercise guide and the weight information of the user. The controller 180 may output a tactile signal for guiding an exercise pace of the user based on the corrected exercise pace of the guider.

Meanwhile, the controller 180 may acquire the weight information of the user based on an user input through the input unit 120, data stored in the memory 170, or data received through the wireless communication unit 110. The weight information of the guider included in the exercise guide may also be acquired in the same manner.

On the other hand, the controller 180 may correct an exercise pace such that the user consumes the same calorie amount as the guider. For example, when temperature when the user exercises is 30° C. and temperature when the guider exercises is 23° C. and thus a calorie amount consumed by an exercise of the user is greater than a calorie amount consumed by an exercise of the guider, the controller 180 may correct an exercise pace of the guider to an exercise pace having a lower level than the exercise pace such that the user exercising at 30° C. consumes the same calorie amount as a calorie amount consumed at 23° C. by the guider.

Meanwhile, the controller 180 may correct an exercise pace of the guider included in the exercise guide based on a user input.

Specifically, when a user input of setting exercise intensity of the user with respect to the exercise guide is received through the input unit 120, the controller 180 may correct the exercise pace of the guider included in the exercise guide based on the user input.

For example, when a user input of setting exercise intensity of the user to 90% of exercise intensity of the guider is received, the controller 180 may correct an exercise pace of the guider to 90% of the exercise pace of the guider.

In addition, when a user input of performing setting such that only a specific calorie amount is consumed is received through the input unit 120, the controller 180 may correct the exercise pace of the guider included in the exercise guide based on the user input.

For example, when a calorie amount consumed during an entire exercise of the guider is 600 kcal and a user input of perform setting such that the user consumes a calorie amount of 80% of the calorie amount consumed by the guider, the controller 180 may correct an exercise pace of the guider such that an calorie amount during an entire exercise of the user is 480 kcal.

Meanwhile, an exercise pace of the guider may be corrected at a certain rate in an entire course in which the guider exercises. However, the present disclosure is not limited thereto, and the controller 180 may correct an exercise pace of the guider based on slope information of a course in which the user moves.

Specifically, the controller 180 may acquire slope information of a course in which the user moves, based on information on a plurality of positions included in an exercise guide and slope information corresponding to the information on the plurality of positions. The controller 180 may acquire information on a course in which an exercise pace of the guider is to be corrected based on the acquired slope information. The controller 180 may correct the exercise pace of the guider in the course in which the exercise pace of the guider is to be corrected.

For example, when the exercise pace of the guider is corrected to an exercise pace having a higher level than the exercise pace of the guider, the controller 180 may correct the exercise pace of the guider to the exercise pace having the higher level in a downhill course in which an exercise pace of the user is easy to increase.

In another example, when the exercise pace of the guider is corrected to an exercise pace having a lower level than the exercise pace of the guider, the controller 180 may correct the exercise pace of the guider to the exercise pace having the lower level in an uphill course in which an exercise pace of the user is easy to decrease.

On the other hand, the controller 180 may correct an exercise pace of the guider included in an exercise guide based on geographic information of a course included in the exercise guide, in which the guider exercises, and geographic information of a course in which the user exercises.

When an exercise pace of the user is guided according to a time elapsed since the guider started to exercise and information on an exercise pace corresponding to the elapsed time, consumption of physical strength by an exercise of the user may be different from consumption of physical strength by an exercise of the guider.

For example, when the guider exercises in a flat slope course and the user exercises in an uphill road, an exercise of the user may be more physically difficult than an exercise of the guider.

In this case, the controller 180 may correct an exercise pace of the guider based on slope information included in an exercise guide and slope information during an exercise of the user. The controller 180 may output a tactile signal for guiding an exercise pace of the user based on the corrected exercise pace of the guider.

For example, when the guider exercises in a flat course to a time when 10 minutes has elapsed since the guider started to exercise and the user exercises in a course having a slope of 10° to a time when 10 minutes has elapsed since the user started to exercise, the controller 180 may correct an exercise pace of the guider to a time when 10 minutes has elapsed since the guider started to exercise, to an exercise pace having a lower level than the exercise pace of the guider. The controller 180 may output a tactile signal for guiding an exercise pace of the user based on the corrected exercise pace of the guider.

On the other hand, the controller 180 may correct an exercise pace such that the user consumes the same calorie amount as the guider. For example, when the guider exercises in a flat course and the user exercises in a course having a slope of 10° and thus a calorie amount consumed by an exercise of the user is greater than a calorie amount consumed by an exercise of the guider, the controller 180 may correct an exercise pace of the guider to an exercise pace having a lower level than the exercise pace such that the user exercising in a course having a slope of 10 consumes the same calorie amount as a calorie amount consumed in the flat course by the guider.

On the other hand, the controller 180 may acquire information on a course in which the user moves, through the sensing unit 140. To this end, the sensing unit may include at least one of an altitude sensor and an atmospheric pressure sensor. In addition, the controller 180 may acquire slope information of a course in which the user moves, by receiving information slope information of a current position of the user. Furthermore, the controller 180 may receive slope information of a course in which the user moves, from the outside through the wireless communication unit 110.

Meanwhile, geographic information included in the exercise guide may also be acquired in the same manner.

As described above, according to the present disclosure, an exercise guide may be corrected according to an exercise environment between the guider and the user, thereby providing an exercise guide further matching an exercise environment of the user.

On the other hand, the controller 180 may correct an exercise pace of the guider included in an exercise guide based on the exercise pace of the guider included in the exercise guide and an exercise pace of the user acquired through the sensing unit 140. Specifically, when an exercise pace of the user in a specific course is different from an exercise pace of the guider, the controller 180 may correct an exercise pace of the guider in a course after the specific course.

This will be described in detail with reference to FIG. 11.

When an exercise pace of the user in a specific course is lower than an exercise pace of the guider in the same course as the specific course, the controller 180 may correct an exercise pace of the guider to an exercise pace having a higher level than the exercise pace in a course after the specific course.

For example, as illustrated in FIG. 11A, when an exercise pace of the user is lower than an exercise pace of the guider in a course between position (a) and position (b), as illustrated in FIG. 11B, the controller 180 may correct an exercise pace of the guider to an exercise pace having a higher level than the exercise pace in a course after the course between position (a) and position (b).

Similarly, when an exercise pace of the user in a specific course is higher than an exercise pace of the guider in the same course as the specific course (i.e., the user takes pace over compared to the guider), the controller 180 may correct an exercise pace of the guider to an exercise pace having a lower level than the exercise pace in a course after the specific course.

On the other hand, the controller 180 may correct an exercise pace such that the user consumes the same calorie amount as the guider. For example, when a calorie amount consumed during an entire exercise of the guider is 600 kcal, the controller 180 may correct an exercise pace of the guider after the specific course such that an calorie amount during an entire exercise of the user is 600 kcal. That is, when a calorie amount consumed by the guider up to distance (b) is 200 kcal and a calorie amount consumed by the user after distance (b) is 400 kcal, the controller 180 may correct an exercise pace of the guider such that the calorie amount consumed by the user after distance (b) is 450 kcal, when a calorie amount consumed by the user up to distance (b) is 150 kcal.

On the other hand, the controller 180 may correct an exercise pace of the guider based on an exercise pace of the guider included in the exercise guide and an exercise pace of the user acquired through the sensing unit 140, and slope information acquired through the sensing unit 140.

Specifically, when an exercise pace of the user in a specific course is lower than an exercise pace of the guider in the same course as the specific course, the controller 180 may correct an exercise pace of the guider to an exercise pace having a higher level than the exercise pace in a course after the specific course In this case, the controller 180 may determine whether an exercise course of the user is a course in which an exercise pace of the guider is corrected, based on slope information acquired through the sensing unit 140 or slope information corresponding to each of a plurality of positions included in an exercise guide. When the exercise course is a course in which an exercise pace of the user is increased, the controller 180 may correct an exercise pace of the guider to an exercise pace having a higher level that the exercise pace of the guider.

For example, it is difficult to increase an exercise pace of the user in an uphill course in which relatively great physical strength is consumed, but it is easy to increase an exercise pace of the user in a downhill course in which relatively small physical strength is consumed. Therefore, as illustrated in FIG. 11B, the controller 180 may acquire slope information in a course after the specific course and may correct an exercise pace of the guider to an exercise pace having a higher level that the exercise pace of the guider in a downhill course after the specific course based on the acquired slope information.

In another example, when the user takes pace over compared to the guider, a case in which a pace of the user is decreased in an uphill course in which relatively great physical strength is consumed rather than a downhill course in which relatively small physical strength is consumed is favorable to the user. Therefore, the controller 180 may acquire slope information in a course after the specific course and may output a tactile signal by using an exercise pace of the guider corrected to an exercise pace having a higher level that the exercise pace of the guider in an uphill course of courses after a specific course based on the acquired slope information.

Meanwhile, in the present embodiment, it has been described that an exercise pace is corrected such that the user consumes the same calorie amount as the guider, the present disclosure is not limited thereto. For example, the controller 180 may correct an exercise pace of the guider after a specific course such that an elapsed time during an entire exercise of the user is the same as an elapsed time during an entire exercise of the guider.

Meanwhile, the controller 180 may correct an exercise pace of the guider included in an exercise guide based on a heart rate of the user acquired during an exercise of the user.

For example, while the user exercises at an exercise pace corresponding to an exercise pace of the guider, when a heart rate of the user increases to a risk value or more, the controller 180 may correct the exercise pace of the guider to a lower level and may guide the exercise pace of the user based on the corrected exercise pace of the guider.

As described above, according to the present disclosure, an exercise guide may be corrected according to various situations occurring while the user exercises, thereby providing an exercise guide further matching exercise performance of the user.

For example, when the user does not keep up with an exercise pace of the guider, an exercise guide may be corrected such that the exercise pace is increased in a downhill course in which it is easy for the user to increase an exercise pace., thereby proving an exercise guide further matching exercise performance of the user.

In another example, when a heart rate is increased to a risk value while the user keeps up with an exercise pace of the guider, an exercise guide may be corrected, thereby reducing riskiness according to a difference between exercise performance of the user and exercise performance of the guider.

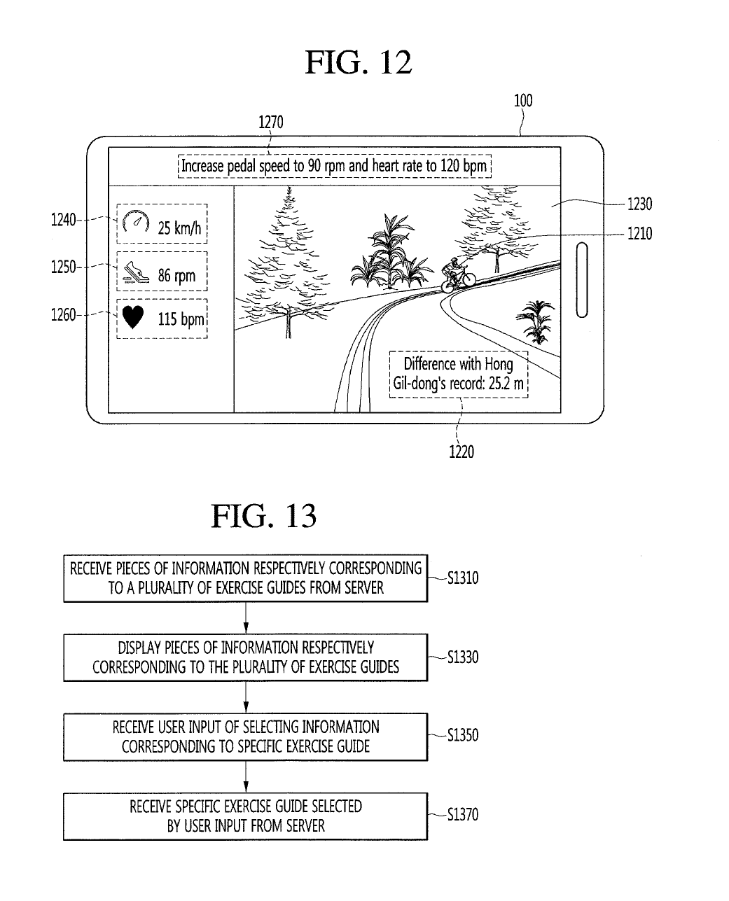

FIG. 12 is a diagram illustrating a method of displaying an object corresponding to an exercise pace of a guider, according to an embodiment of the present disclosure.

FIG. 12, it is described that the present embodiment is implemented in a mobile terminal, but the present disclosure is not limited thereto. The present embodiment may be implemented in the watch-type mobile terminal 100. In addition, the present embodiment may be implemented in a manner in which the watch-type mobile terminal 100 outputs a tactile signal and a mobile terminal interworking with the watch-type mobile terminal 100 displays an object.

The controller 180 may control the display unit 151 to display an object corresponding to an exercise pace of the guider based on an exercise pace of a user and the exercise pace of the guider.

Specifically, the controller 180 may acquire a movement distance of the guider at a time when a first time has elapsed since the guider started to exercise, based on an exercise pace of the guider. In addition, the controller 180 may acquire a movement distance of the user at a time when the first time has elapsed since the user started to exercise, based on an exercise pace of the user.

In this case, the controller 180 may calculate a difference between the movement distance of the guider and the movement distance of the user and may display an object corresponding to an exercise pace of the guider by using the calculated difference.

For example, as illustrated in FIG. 12, when the guider moves more than a movement distance of the user by 25.2 meters for a specific time after starting to exercise, the controller 180 may display an object 1210 corresponding to an exercise pace of the guider at a position ahead of a current position of the user by 25.2 meters.

In addition, the controller 180 may display a user interface (UI) 1220 indicating a difference between a movement distance of the guider and a movement distance of the user.

In this case, the controller 180 may acquire an image through the input unit 120 and may display the acquired image 1230 to allow the user to intuitionally determine an exercise pace of the user and an exercise pace of the guider.

On the other hand, when an exercise pace of the user is guided through displaying, as illustrated in FIG. 12, the controller 180 may display at least one of current exercise paces 1240 and 1250 of the user, a heart rate 1260 of the user, and a UI 1270 for guiding an exercise pace of the user.

As described above, according to the present disclosure, an object corresponding to an exercise pace of the guider may be displayed, thereby allowing the user to intuitionally determine a difference between an exercise pace of the user and an exercise pace of the guider.

Meanwhile, a plurality of pieces of information included in an exercise guide may be acquired in real time while an exercise pace of the user is guided based on the exercise guide.

For example, while an exercise pace of the user located at a first position is guided based on the first position included in an exercise guide and information on an exercise pace of the guider corresponding to the first position, the controller 180 may receive a second position and information on an exercise pace of the guider corresponding to the second position from the outside. When the user passes through the first position and then is located at the second position, the controller 180 may guide an exercise pace of the user such that the user exercises according to information on an exercise pace of the guider corresponding to the second position.

In this case, the user may exercise based on exercise information of the guider shared in real time. For example, the user may exercise based on exercise information of the guider while exercising at the same time as the guider. In this case, even when the guider and the user are located in different regions, as described above, an exercise pace may be corrected according to weather or geographic information.

On the other hand, FIG. 3, it has been described that the watch-type mobile terminal 100 is capable of acquiring an exercise guide generated using exercise information of the guider. When the guider is a user of each of the other mobile terminals, i.e., an exercise guide is a guide generated based on an exercise record of the user of each of the other mobile terminals, a method of acquiring an exercise guide will be described.

FIG. 13 is a flowchart of a method of acquiring an exercise guide when the guider is a user of each of the other mobile terminals, according to an embodiment of the present disclosure.

According to FIG. 13, acquiring of an exercise guide may include receiving pieces of information respectively corresponding to a plurality of exercise guides from a server (S1310), displaying the received pieces of information respectively corresponding to the plurality of exercise guides (S1330), receiving a user input of selecting information corresponding to a specific exercise guide from the received pieces of information respectively corresponding to the plurality of exercise guides (S1350), and receiving the specific exercise guide selected by the user input from the server (S1370).

On the other hand, in the following embodiments, it is described that a method of acquiring an exercise guide when the guider is the user of each of the other mobile terminals is implemented in the mobile terminal, but the present disclosure is not limited thereto. The present embodiment may be implemented in the watch-type mobile terminal 100.

In addition, when an exercise guide is acquired in the mobile terminal according to the present embodiment, the present embodiment may be implemented in a manner in which a tactile signal corresponding to the acquired exercise guide in the watch-type mobile terminal 100 interworking with the mobile terminal.

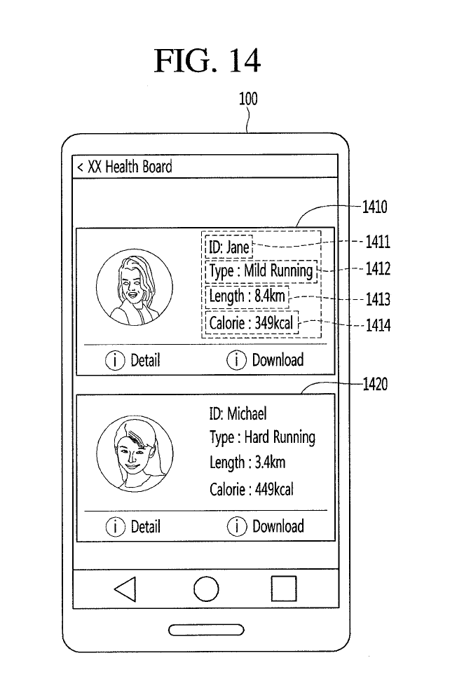

The displaying of the received pieces of information respectively corresponding to the plurality of exercise guides (S1330) and the displaying of the received pieces of information respectively corresponding to the plurality of exercise guides (S1330) will be described in detail with reference to FIG. 14.

FIG. 14 is a diagram illustrating a screen on which pieces information respectively corresponding to a plurality of exercise guides received from the server are displayed.

The controller 180 may receive pieces of information 1410 and 1420 respectively corresponding to a plurality of exercise guides received from the server through the wireless communication unit 110.

Among the pieces of information 1410 and 1420 respectively corresponding to the plurality of exercise guides, first information 1410 corresponding to a first exercise guide may include exercise information of a first guider corresponding to the first exercise guide. Here, the first guider may be a user of a first mobile terminal generating the first exercise guide. That is, when the user of the first mobile terminal exercises, the first exercise guide may be an exercise guide generated based on exercise information of the user of the first mobile terminal by the first mobile terminal.

In addition, among the pieces of information 1410 and 1420 respectively corresponding to the plurality of exercise guides, second information 1420 corresponding to a second exercise guide may include exercise information of a second guider corresponding to the second exercise guide Here, the second guider may be a user of a second mobile terminal generating the second exercise guide. That is, when the user of the second mobile terminal exercises, the second exercise guide may be an exercise guide generated based on exercise information of the user of the second mobile terminal by the second mobile terminal.

Meanwhile, the pieces of information 1410 and 1420 respectively corresponding to the plurality of exercise guides may be generated based on exercise guides uploaded to the server from mobile terminals respectively generating the plurality of exercise guides. For example, when the first mobile terminal uploads an exercise guide, the server may generate the information 1410 corresponding to the exercise guide uploaded from the first mobile terminal.

On the other hand, the pieces of information 1410 and 1420 respectively corresponding to the plurality of exercise guides at least one of an exercise type, an exercise course, an exercise distance, an exercise time, a physical condition, a consumed calorie amount of guiders respectively corresponding to the plurality of exercise guides.

In addition, the controller 180 may display the pieces of information 1410 and 1420 respectively corresponding to the plurality of exercise guides.

For example, the controller 180 may display the information 1410 corresponding to the first exercise guide including information on at least one of an exercise type 1412, an exercise distance 1413, and a consumed calorie amount 1414, which are performed by a guider corresponding to the first exercise guide. However, the present disclosure is not limited thereto, and the controller 180 may display the information on the first exercise guide including at least one of an exercise course, an exercise time of the guider corresponding to the first exercise guide.

In addition, the controller 180 may display identification information 1411 of the guider corresponding to the first exercise guide.

Returning to FIG. 13 again, the method of acquiring the exercise guide when the guider is the user of each of the other mobile terminals may include receiving the user input of selecting the information corresponding to the specific exercise guide from the pieces of displayed information respectively corresponding to the plurality of exercise guides (S1350).

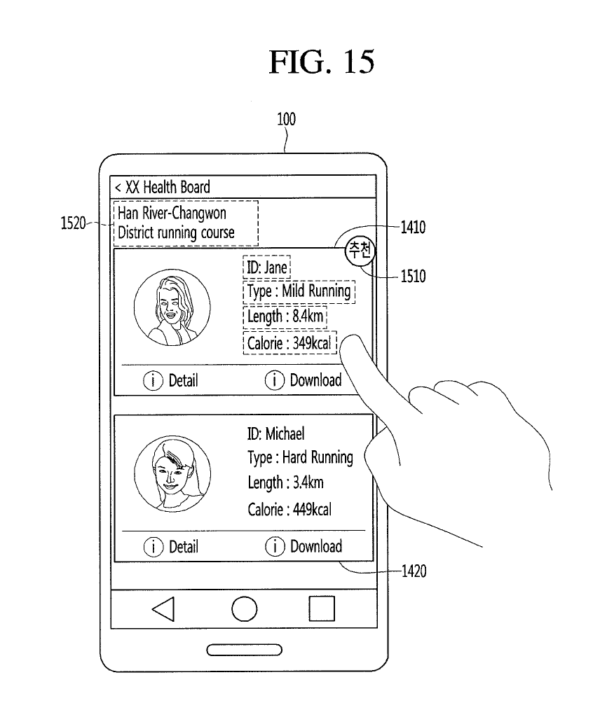

This will be described in detail with reference to FIG. 15.

FIG. 15 is a diagram illustrating a method of receiving a user input of selecting information corresponding to a specific exercise guide from pieces of displayed information respectively corresponding to a plurality of exercise guides.

According to FIG. 15, the controller 180 may receive a user input of selecting the information 1410 corresponding to the first exercise guide from the pieces of information 1410 and 1420 on the plurality of displayed exercise guides.

Meanwhile, the controller 180 may display a UI for recommending a specific exercise guide of the plurality of exercise guides corresponding to a physical condition of the user based on a physical condition of the guider and the physical condition of the user corresponding to each of the plurality of exercise guides.

Specifically, pieces of information and respectively corresponding to a plurality of exercise guides received by the mobile terminal 100 from the server may include pieces of information on physical conditions of guiders respectively corresponding to the plurality of exercise guides. For example, the information 1410 corresponding to the first exercise guide may include information indicating that a height of a guider is 173 cm and weight of the guider is 60 kg. In another example, the information 1420 corresponding to the second exercise guide may include information indicating that a height of a guider is 183 cm and weight of the guider is 75 kg.

The controller 180 may display a UI 1510 for recommending a specific exercise guide of the plurality of exercise guides corresponding to a physical condition of the user based on a physical condition of the guider and the physical condition of the user corresponding to each of the plurality of exercise guides. Specifically, the controller 180 may compare the physical condition of the guider with the physical condition of the user corresponding to each of the plurality of exercise guides and may determine that a specific exercise guide corresponding to a guider best matching the physical condition of the user is any one of the plurality of exercise guides. For example, when a height of a user is 174 cm and weight of the user is 61 kg, the controller 180 may determine that an exercise guide of a guider best matching a physical condition of the user is the first exercise guide. The controller 180 may display the UI 1510 for recommending the first exercise guide.

On the other hand, a physical condition of a user may be acquired by a user input through the input unit 120 or may be received from the server through the wireless communication unit 110.

Meanwhile, in the present embodiment, it has been described that an exercise guide is recommended based on a physical condition and a physical condition of a user, but the present disclosure is not limited thereto.

Specifically, the controller 180 may recommend an exercise guide based on an exercise course of a guider and position information of a user. For example, when an exercise course of a guider is “Hangang Jamwon Area” and a position of the mobile terminal 100 is near “Hangang Jamwon Area”. the controller may display a UI for recommending information on an exercise course nearest to a current position of a user.

In FIGS. 14 and 15, it has been described that the mobile terminal 100 receives pieces of information corresponding to a plurality of exercise guides and then recommends a specific exercise guide, but the present disclosure is not limited thereto.

That is, the mobile terminal 100 may receive pieces of information corresponding to a plurality of exercise guides based on a user input of designating kinds of exercise guides. For example, when a user input of designating an exercise guide in which an exercise type is “Mild Running” is received, the controller 180 may receive only information corresponding to the exercise guide in which the exercise type is “Mild Running”.

In another example, when a user input of designating an exercise guide in which an exercise course is a current position of a user, the controller 180 may sequentially receive pieces of information from information corresponding to an exercise guide including an exercise course nearest to a current position of the mobile terminal 100. In this case, as illustrated in FIG. 15, the controller may display a UI 1520 for indicating a kind of received exercise guide.

In another example, when a user input of designating a physically condition (for example, a height: 170 cm to 175 cm and weight: 70 kg to 75 kg) of a guider included in an exercise guide is received, the controller 180 may only receive an exercise guide of a guider best matching a physical condition designated by a user.

Returning to FIG. 13 again, the method of acquiring the exercise guide when the guider is the user of each of the other mobile terminals may include receiving the specific exercise guide selected by the user input from the server (S1370).

The controller 180 may receive a specific exercise guide selected by a user input through the wireless communication unit 110. In this case, the received specific exercise guide may include information on a plurality of positions on a movement route of a guider corresponding to the specific exercise guide and information on a plurality of exercise paces respectively corresponding to the plurality of positions. In addition, the specific exercise guide may include information on a plurality of times elapsed since the guider started to exercise and information on a plurality of exercise guides respectively corresponding to the plurality of times elapsed since the guider started to exercise.

The received specific exercise guide may include an exercise distance, an exercise time, average speed, maximum speed, consumed calories, a required water intake, a minimum altitude and a maximum altitude on a movement route, weather information during an exercise, and slope information on the movement route of a guider.

The controller 180 may output a tactile signal for guiding a user to exercise at an exercise pace of a guider based on information included in the received exercise guide. In addition, the controller 180 may correct information on a plurality of exercise paces included in the received exercise guide based on information included in the received exercise guide.

On the other hand, in the present embodiment, it has been described that information corresponding to an exercise guide and the exercise guide are received through the server, but the present disclosure is not limited thereto. For example, information corresponding to an exercise guide and the exercise guide may be received from an external device connected through short-range wireless communication or an interface unit.

As described above, according to the present disclosure, a plurality of persons may upload exercise guides thereof, thereby providing an environment in which the exercise guides are shared with other people.

In addition, the user of the watch-type mobile terminal may selectively receive an exercise guide to be used among a plurality of uploaded exercise guides and may exercise by using an exercise guide matching preference thereof.

Furthermore, according to the present disclosure, an exercise guide may be recommended according to preference and a physical condition of a user, thereby proving an exercise guide suitable for the user.

On the other hand, a user may generate an exercise guide including exercise information thereof to transmit the generated exercise guide, so that the user may share the exercise guide thereof with other people.

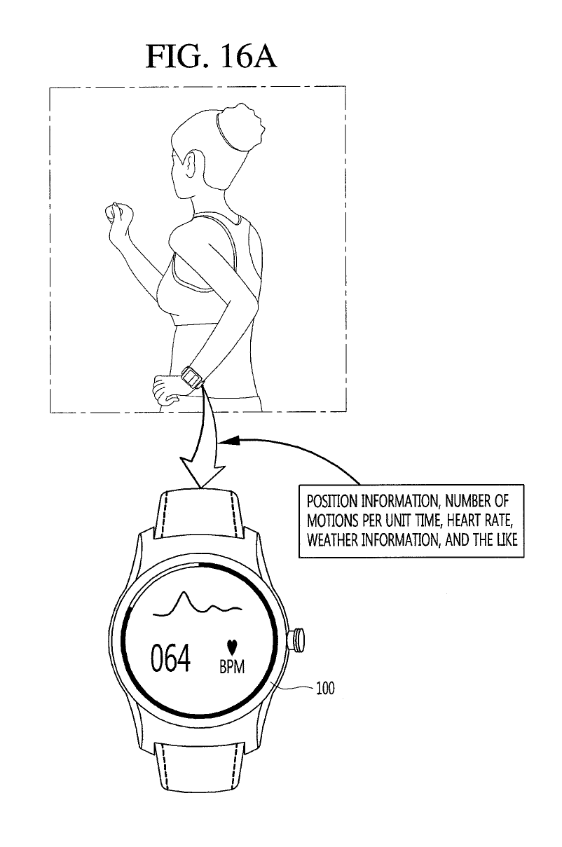

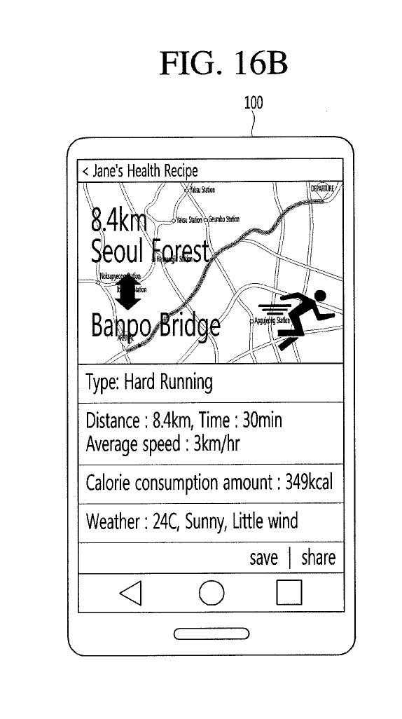

This will be described in detail with reference to FIG. 16.

FIG. 16 is a diagram illustrating a method of generating an exercise guide of the user of the watch-type mobile terminal 100, transmitting the generated exercise guide to the server, and sharing exercise guide of the user with bother people.

As illustrated in FIG. 16A, the controller 180 may acquire exercise information of a user. Specifically, the controller 180 may acquire information on a plurality of positions on a movement route of a user through the wireless communication unit 110. In addition, the controller 180 may acquire information on a plurality of exercise paces respectively corresponding to the plurality of positions though the sensing unit 140.

Furthermore, the controller 180 may acquire information indicating that a user starts to exercise based on a user input indicating that the user starts to exercise or a movement of the user sensed through the sensing unit 140. The controller 180 may acquire information on a plurality of times elapsed since the user started to exercise and information on a plurality of exercise paces respectively corresponding to the plurality of times.

In addition, the controller 180 may acquire at least one of an exercise type, an exercise course, an exercise distance, an exercise time, a physical condition, consumed calories, average speed, maximum speed, a required water intake, a minimum altitude and a maximum altitude on a movement route, weather information during an exercise, and slope information on the movement route of a user. The controller 180 may acquire the above-described pieces of information through sensing of the sensing unit 140, information received through the wireless communication unit 110, or a user input received through the input unit 120.

FIG. 16B is a diagram illustrating an exercise guide generated based on exercise information of a user.

The exercise guide generated based on the exercise information of the user may include pieces of information acquired in the watch-type mobile terminal 100 illustrated in FIG. 16A.

The controller 180 may transmit the exercise guide generated based on the exercise information of the user to the server.

As described above, according to the present disclosure, it is possible to provide an environment in which the user of the watch-type mobile terminal uploads an exercise guide thereof to share the uploaded exercise guide with other people.

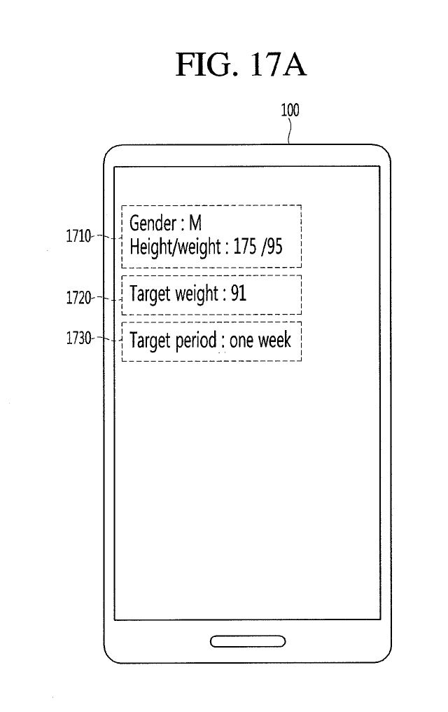

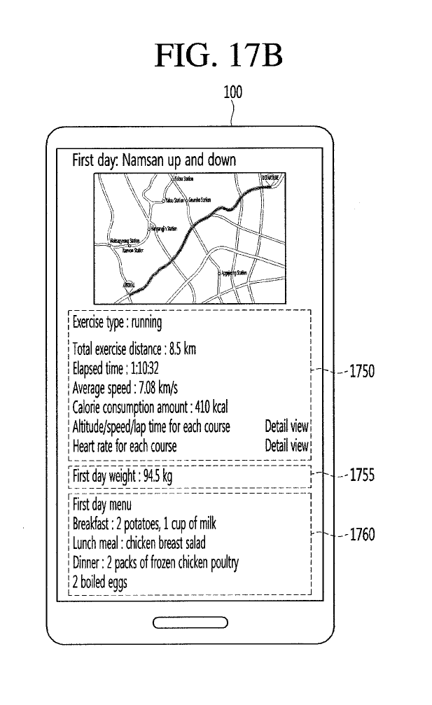

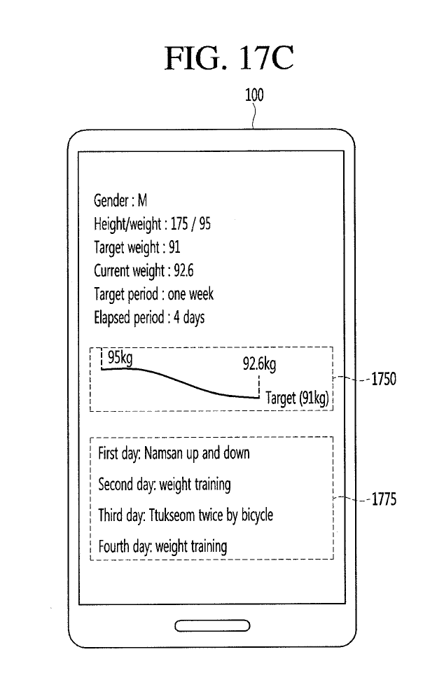

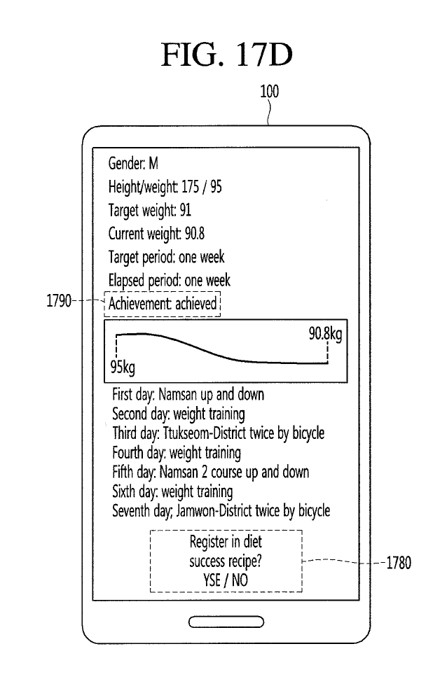

FIGS. 17 to 20 are diagrams illustrating a method of sharing a diet guide, according to another embodiment of the present disclosure.

The diet guide includes a physical condition, exercise information, menu information, or a transition of a change in weight of a guider. The diet guide means a guide usable to a diet of other people.

The diet guide may include information on at least one of a physical condition, target weight, menu information, and a diet period of a user.

Specifically, the controller 180 may receive a user input of inputting a physical condition of a user. For example, as illustrated in FIG. 17A, the controller 180 may acquire a physical condition 1710 including at least one of a gender, a height, and weight of a user and may display the acquired physical condition 1710.

In addition, the controller 180 may receive a user input for setting target weight and may display information 1720 on the target weight.

Furthermore, the controller 180 may receive a user input of setting a diet period and may display information 1730 on the diet period.

On the other hand, the diet guide may include a exercise guide. Specifically, as illustrated in FIG. 17B, the controller 180 may acquire an exercise information of a user and may display the acquired exercise information 1750 of the user. Meanwhile, a method of acquiring exercise information illustrated in FIG. 16 may be applied to a method of acquiring exercise information of a user.

On the other hand, the diet guide may include information on weight of a user and a menu guide of the user. Specifically, the controller 180 may acquire information 1755 on weight of a user or information 1760 on a menu of the user through sensing of the sensing unit 140, information received through the wireless communication unit 110, or a user input received through the input unit 120. The controller 180 may display the acquired information 1755.

On the other hand, the diet guide may include an exercise guide, a menu guide, and weight information fro each period. For example, the diet guide may include a first day exercise guide, a first day menu guide, and first day weight information. The diet guide may include a second day exercise guide, a second day menu guide, and second day weight information. Therefore, when a diet period is 7 days, the diet guide may include an exercise guide, a menu guide, and weight information from a first day to a second day.

Referring to FIG. 17C, a diet guide may include one or more exercise guides. For example, when a user has ran on a first diet day, did weight tanning on a second diet day, rod a bicycle on a third diet day, and did weight tanning on a fourth diet day, a diet guide may include four exercise guides. The controller 180 may display a title 1775 of plurality of exercises guides.

Meanwhile, it has been described that exercise information is acquired through the sensing unit 140, but the present disclosure is not limited thereto. Specifically, the controller 180 may receive a user input for inputting exercise information through the input unit 120 and may store the received exercise information. For example, when an user input indicating that 3 sets of bench presses (15 times/set), 3 sets of squats (20 times/set), and 3 sets of dead lifts (15 times/set) were performed in a second day weight training, the controller 180 may store the 3 sets of bench presses (15 times/set), the 3 sets of squats (20 times/set), and the 3 sets of dead lifts (15 times/set) as information corresponding to the second day weight training.

On the other hand, a diet guide may include one or more menu guides. For example, a diet guide may include information on a first day menu, a second day menu, a third day menu, and a fourth day menu.

In addition, a diet guide may include information on one or more weighs of a user. For example, a diet guide may include information on first day weight, second day weight, third day weight, and fourth day weight of a user. In addition, the controller 180 may display a graph 1750 showing a change in weight of a user.

The aforementioned pieces of information included in the guide guides may be included in the memory 170.

FIG. 17D is a diagram illustrating a screen in which generation of a diet guide is completed.

In FIG. 17A, a user sets a diet period to 7 days. When a diet period set by a user elapses, the controller 180 may determine whether the user succeeds in loosing weight, based on current weight of the user. For example, as illustrated in FIG. 17D, when a user set target weight after 7 days as 91 kg and weight of the user is 90.8n kg after 7 days, the controller 180 may determine that the user succeeds in losing weight.

When a diet period elapses, the controller 180 may display a UI 1790 indicating whether a user succeeds in losing weight. Since a user succeeds in losing weight, in FIG. 17d, it is described that the UI indicating that the user succeeds in losing weight is displayed.

In the other hand, when a user succeeds in losing weight, the controller 180 may display a UI 1780 indicating that a diet guide may be shared with other people. When a user input for sharing a diet guide with other people is received, the controller 180 may upload the received diet guide to the server. In this case, the diet guide of the user may be registered as a success case of a diet and may be displayed as a success case of a diet in mobile terminals of other people.

Meanwhile, in the present embodiment, it has been described that only when weight of a user is decreased to target weight or less within a period set by the user, a diet guide is uploaded to the server, but the present disclosure is not limited thereto. For example, although a diet period is not set, when weight of a user is decreased to target weight or less, a diet guide may be directly uploaded to the server.

In addition, in the present embodiment, it has been described that only when weight of a user is decreased to target weight or less, a diet guide is uploaded to the server, but the present disclosure is not limited thereto. For example, weight of a user is not decreased to target weight or less, i.e., a diet fails, a diet guide may be uploaded to the server. Therefore, a success case of a diet as well as a failure case of a diet may be shaped other people.

As described above, according to the present disclosure, it is possible to provide an environment in which a diet guide according to one exercise, a plurality of exercise guides, and a diet guide including menu information and a change in weight according to the menu information are shared with other people.

In addition, according to the present disclosure, only when a user succeeds in loosing weight, a diet guide may be uploaded to the server and thus be shared with other people, thereby inspiring motivating the diet desire of the user.

Furthermore, according to the present disclosure, a success case of a diet as well as a failure case of a diet may be shaped other people, thereby allowing other people to refer to the failure case of the diet.

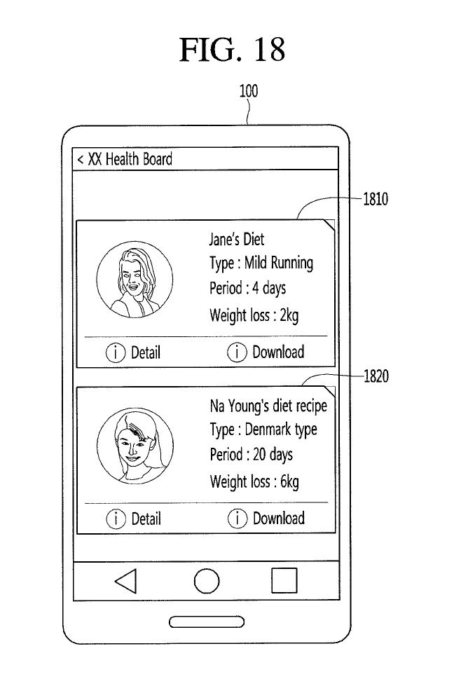

On the hand, in the present embodiment, it has been described that the mobile terminal 100 of the user uploads a diet guide, the present disclosure is not limited thereto. For example, a user as well as other people may upload a diet guide, and the mobile terminal 100 of the user may receive the diet guide uploaded by the other people. This will be described with reference to FIG. 18.

FIG. 18 is a diagram illustrating an diet guide acquiring method of other people, according to an embodiment of the present disclosure.

The controller 180 may receive pieces of information 1810 and 1820 respectively corresponding to a plurality of diet guides from the server through the wireless communication unit 110.

On the other hand, the pieces of information 1810 and 1820 respectively corresponding to the plurality of diet guides may be generated based on diet guides uploaded to the server by the mobile terminals respectively generating the plurality of diet guides. For example, when a first mobile terminal uploads a diet guide of a first guider, the server may generate information corresponding to the diet guide uploaded by the first terminal and may provide the generated information to the mobile terminal 100.

Each of the pieces of information 1810 and 1820 respectively corresponding to the plurality of diet guides may include information on at least one of a diet type, a diet period, and reduced weight.

In addition, the controller 180 may display the received pieces of information 1810 and 1820 respectively corresponding to the plurality of diet guides.

On the other hand, each of the pieces of information 1810 and 1820 respectively corresponding to the plurality of diet guides may include detail information on each of the plurality of diet guides. Here, the detail information on each of the plurality of diet guides may include information on a change in weight of a guider according to a period.

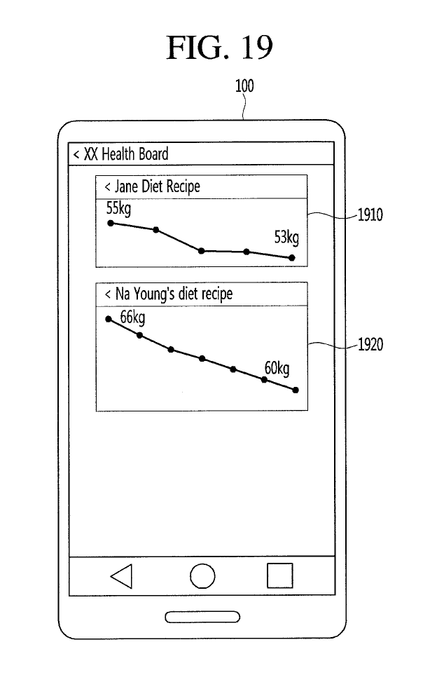

When a user input for confirming detail information on each of the plurality of diet guides is received, as illustrated in FIG. 19, the controller 180 may display pieces of information 1910 and 1920 on a change in weight of a guider according to a period.

Meanwhile, in the present embodiment, it has been described that detail information on each of a plurality of diet guides is information on a change in weight of a guider according a period, but the present disclosure is not limited thereto. That is, detail information on each of a plurality of diet guides is information may include all information included in a diet guide illustrated in FIG. 17, and the controller 180 may receive and display the detail information on each of the plurality of diet guides is information according to a user input.

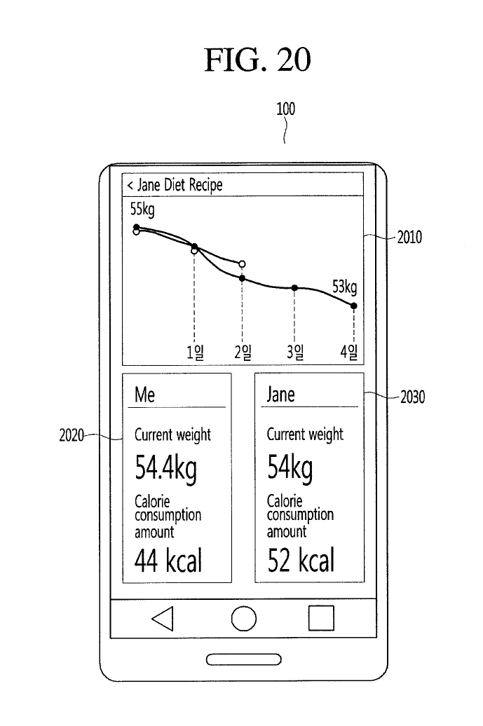

FIG. 20 is a diagram illustrating a screen of a mobile terminal of a user who goes a diet by using a diet guide acquired from the outside, according to an embodiment of the present disclosure.

When a user input of selecting information corresponding to a specific diet guide from pieces of information 1910 and 1920 respectively corresponding to a plurality of diet guides is received, the controller 180 may receive a diet guide selected by a user from the server.

In addition, the controller 180m may guide an exercise pace of the user based on the received diet guide. For example, when the received diet guide includes one or more exercise guides, the controller 180 may guide an exercise pace of the user based on the received one or more exercise guides. A method of guiding an exercise pace of a user has been described in FIGS. 3 to 12, detailed descriptions thereof will be described.

In addition, the controller 180 may display menu information included in the received diet guide. Furthermore, the controller 180 may display information on a change in weight for each period included in the received diet guide.

On the other hand, the controller 180 may divide and display a plurality of pieces of information included in the diet guide according to periods. For example, when the received diet guide includes a first day exercise guide, a first menu guide, first weight information, a second day exercise guide, a second day menu guide, and second day weight information, the controller 180 may display information corresponding to a first day (the first day exercise guide, the first menu guide, and the first weight information) and may separately display or divide and display information corresponding to a second day (the second day exercise guide, the second day menu guide, and the second day weight information).

On the other hand, the controller 180 may acquire information on weight of a user through sensing of the sensing unit 140 or information received through the wireless communication unit 110.

The controller 180 may display at least one of weight 2020 of a user and weight 2030 of a guider at a time when a specific period has elapsed since a diet started. For example, the controller 180 may display weight of a guider at time when two days have elapsed since the guider started a diet. In addition, the controller 180 may display weight of a user at time when two days have elapsed since the user started a diet by using a diet guide.

Furthermore, the controller 180 may display a graph 2010 showing a change in weight of a guider and a change in weight of a user according to a period.

On the other hand, the controller 180 may acquire information on a diet effect of a user using a specific diet guide based on weight information of the user and weight information of a guider included in a diet guide. Specifically, the controller 180 may calculate a change in weight of a user who goes a diet by using a specific diet guide. In addition, the controller 180 may calculate a change in weight of a guider based on weight information of the guider included in a diet guide. Furthermore, when a difference between the change in weight of the guider and the change in weight of the user is greater than or equal to a reference value, the controller 180 may display a UI for recommending a change of a diet guide.

In addition, when a difference between the change in weight of the guider and the change in weight of the user is greater than or equal to the reference value, the controller 180 may display information on a diet guide corresponding to a physical condition of the user. For example, the controller 180 may receive and display information on a diet guide which best matches a physically condition of a user, based on height and weight information of the user and height and weight information of a guider.

As described above, according to the present disclosure, a plurality of people may upload diet guides thereof, thereby providing an environment in which the diet guides are shared with other peoples.

In addition, a user of a watch-type mobile terminal may go a diet by using a diet guide matching preference of the user among a plurality of uploaded diet guides.

Furthermore, according to the present disclosure, when the use effect of a specific diet guide is small due to a constitution difference and a life pattern difference between a user and a guider, other diet guides matching a physical condition of the user may be recommended to the user using the specific diet guide.

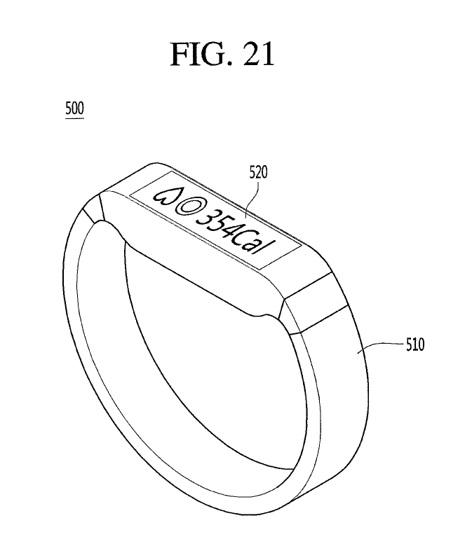

FIG. 21 is a diagram illustrating an operating method of a wearable device, according to another embodiment of the present disclosure.

Referring to FIG. 21, the present disclosure may be implemented through a band type wearable device 500, and the band type wearable device 500 (hereinafter, referred to as a “smartband”) may be used in a state of being worn on an arm of a user.

The smartband 500 may include a body 510 having a band portion and a display unit 520.

The body 510 may be provided with various electronic components. The body 510 may include at least one of a wireless communication unit, an input unit, a sensing unit, an output unit, an interface unit, a memory, a controller, and a power supply unit.

The wireless communication unit may wirelessly communicates with an external device and may transmit or receive data.

The input unit may include an image input unit for inputting an image signal, an input unit for inputting an audio signal, and a user input unit for receiving information from a user (for example, a touch key, a push key, a mechanical key, or the like). Voce data or image data collected in the input unit may be analyzed and be processed according to user commands.

The sensing unit may include one or more sensors configured to sense at least one of information inside the smartband 500, surrounding environment information around the smartband 500, and user information. For example, the sensing unit may include at least one of a proximity sensor, an illumination sensor, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, a camera), a microphone, a battery gauge, an environment sensor (for example, a barometer, a hygrometer, a thermometer, a radiation detection sensor, a thermal sensor, a gas sensor, and the like), and a chemical sensor (for example, an electronic nose, a health care sensor, a biometric sensor, and the like).

On the other hand, the smartband 500 described in the present specification may combine and use pieces of information sensed in two or more sensors of the above-described sensors.

The output unit is configured to output acoustic output, tactile output, or the like. The output unit may include at least one of an audio output unit, a haptic module, and an optical output module.

The interface unit functions as an interface with various types of external devices that can be coupled to the smartband 500.

The memory may sore data to support various functions of the smartband 500.

The controller may control operation of the smartband 500 by using an application program stored in the memory. In addition, the controller may control overall operation of the smartband 500.

The power supply unit may receive external power and internal power to supply power to respective elements included in the smartband 500 under control of the controller. The power supply unit may include a battery.

The display unit 520 may display (output) information processed in the smartband 500.

On the other hand, the smartband 500 may include all the elements of the mobile terminal illustrated in FIG. 1 or all the elements of the watch-type mobile terminal illustrated in FIG. 2. The smartband 500 may perform all functions of the mobile terminal illustrated in FIG. 1 or the watch-type mobile terminal illustrated in FIG. 2. In addition, all operations described with reference to FIGS. 3 to 20 may be implemented in the smartband 500.

Meanwhile, a wearable device such as the smartband 500 or the watch-type mobile terminal may communicate with a mobile terminal. In addition, some operations described with reference to FIGS. 3 to 20 may be implemented in the wearable device, and the remaining operations described with reference to FIGS. 3 to 20 may be implemented in the mobile terminal communicating with the wearable device. Furthermore, in the above-described embodiment, it has been described that the wearable device include various elements, but the wearable device may include minimum elements for performing some operations implemented in the wearable device.

For example, the smartband 500 may acquire exercise information of a user through the sensing unit and may transmit the acquired exercise information to the mobile terminal through the wireless communication unit. In this case, the mobile terminal may display the acquired exercise information or may acquire an exercise guide of the user by using the received exercise information of the user. In this case, the mobile terminal may store the exercise guide or transmit the exercise guide to the server.

In another example, when the mobile terminal acquires an exercise guide of a guider and transmits the acquired exercise guide to the smartband 500, the controller of the smartband 500 may control the output unit to output a tactile signal for guiding an exercise of the user based on the exercise guide of the guider received through the wireless communication unit and the exercise information of the user acquired through the sensing unit.

In another example, the mobile terminal may directly sense exercise information of a user or may receive the exercise information of the user from the smartband 500. the mobile terminal may transmit an output command of a tactile signal to the smartband 500, the tactile signal being a signal for guiding the user to exercise at an exercise pace of a guider based on an exercise guide of the guider and the exercise information of the user. In this case, the controller of the smartband 500 may receive the output command of the tactile signal through the wireless communication unit and may control the output unit to output the tactile signal based on the received output command of the tactile signal.

In the following embodiments, it will be described that the present disclosure is implemented in the smartband 500 and a mobile terminal communicating with the smartband 500. However, the present disclosure is not limited thereto, and the following embodiments may be implemented be implemented in a watch-type mobile terminal and a mobile terminal communicating with the watch-type mobile terminal, solely in the watch-type mobile terminal, or solely in the mobile terminal.

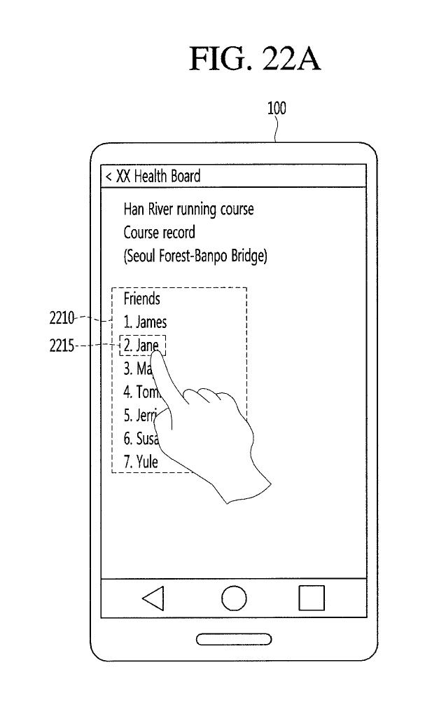

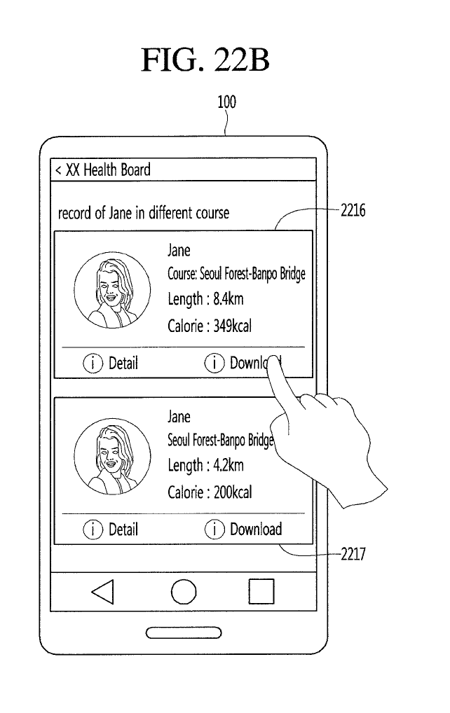

FIG. 22 is a diagram illustrating an operating method of a wearable device, according to another embodiment of the present disclosure.

Referring to FIG. 22A, the controller 180 may display a user list 2210 of a plurality of mobile terminals. Here, users of the plurality of mobile terminals may be users of mobile terminals which upload exercise guides to the server. In addition, the users of the plurality of mobile terminals may be users of mobile terminals which upload exercise guides to the server, among users stored in a phonebook list of the mobile terminal 100.

In this case, only users of mobile terminals generating exercise guides with respect to a specific course may be displayed. For example, when a user acquires information on a specific course (for example, a course between Seoul Forest and Banpo Bridge) in which the user is to exercise, the controller 180 may receive, from the server, pieces of information on users who generate exercise guides with respect to the course between Seoul Forest and Banpo Bridge. The controller 180 may display only the users of mobile terminals generating the exercise guides with respect to the course between Seoul Forest and Banpo Bridge.

In this case, the users of the mobile terminals generating the exercise guides with respect to the specific course may be displayed in an ascending order of an exercise record. For example, the controller 180 may receive exercise records together with pieces of information on the pieces of information on the users who generate the exercise guides with respect to the course between Seoul Forest and Banpo Bridge. The controller 180 may display the users in a descending order from a user exercising for a short time in the same course

Meanwhile, when a user input of selecting a specific user 2215 of the users of the plurality of mobile terminals is received, as illustrated in FIG. 22B, the controller 180 may display pieces of information 2216 and 2217 corresponding to a plurality of exercise guides of the user of the mobile terminal selected by the received user input.

In addition, when a user input of selecting one of the pieces of information 2216 and 2217 corresponding to the plurality of exercise guides is received, the controller 180 may acquire an exercise guide corresponding to the information 2216 selected by a user from the server.

On the other hand, in the present embodiment, it has been described that users of a plurality of mobile terminals are primarily displayed, and then, an exercise guide of a user of a mobile terminal, selected by a user, is received, but the present disclosure is not limited thereto.

For example, the controller 180 may display users of mobile terminals generating exercise guides stored in the mobile terminal 100 in FIG. 22A. Even in this case, only the user stored in the phonebook list of the mobile terminal 100 may be displayed as described above.

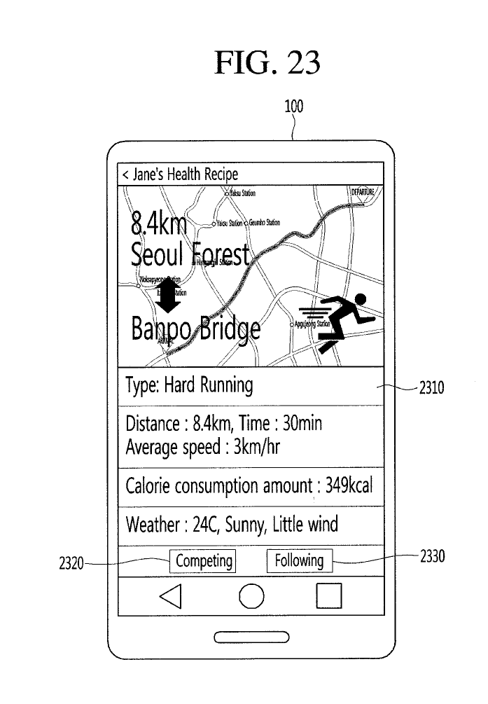

FIG. 23 is a diagram a method of guiding an exercise of a user by using an exercise guide of a guider. When a specific exercise guide is selected through processes of FIG. 22, the controller 180 may display information 2310 corresponding to the exercise guide selected by a user.

The controller 180 may display a UI 2320 corresponding to a first mode and a UI 2330 corresponding to a second mode.

Here, the first mode is a “competing” mode. The first mode may be a mode of providing at least one of comparison results of information on an exercise condition of a user, information on an exercise condition of a guider, an exercise record of the user, and an exercise record of the guider based on exercise information of the user and a exercise information of the guider.

In addition, the first mode may be a mode of guiding an exercise of the user such that the user defeats the guider, based on the exercise information of the user and information on an exercise pace of the guider.

In this case, the controller 180 may provide at least one of comparison results of the information on the exercise condition of the user, the information on the exercise condition of the guider, the exercise record of the user, and the exercise record of the guider through various output methods or may guide an exercise of the user such that the user defeats the guider. For example, as illustrated in FIGS. 1 to 20, the controller 180 may output a visual image through the display unit 151, output a sound through the audio output module 152, or output a tactile signal through the haptic module 153.

Meanwhile, the second mode may a “following” mode. The second mode may be a mode of outputting a tactile signal for guiding the user to exercise at an exercise pace of the guider, based on exercise information of the user and information on the exercise pace of the guider. In addition, the second mode may be a mode of providing other information.

When the user selects the second mode, embodiments illustrated with reference to FIGS. 3 to 20 may be intactly applied, and an operating method when the user selects the first mode (competing mode) will be described in detail.

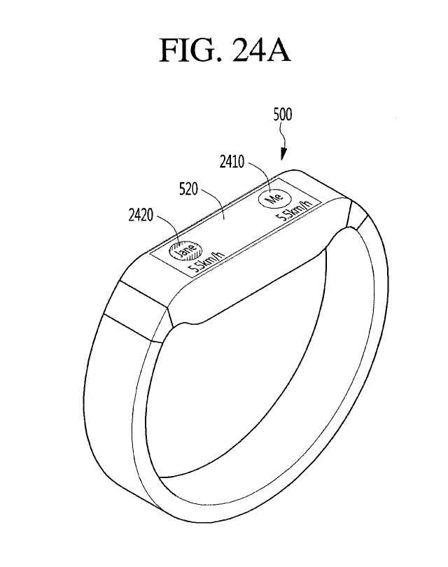

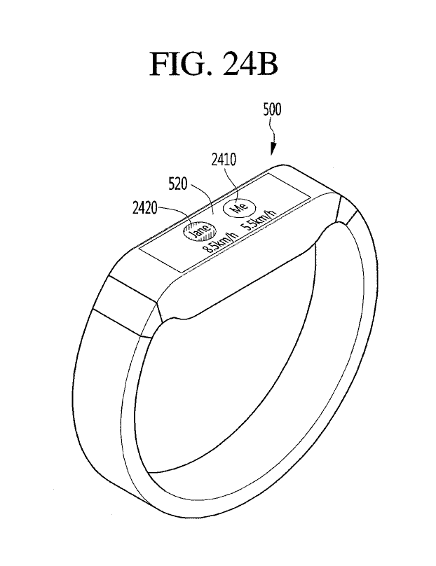

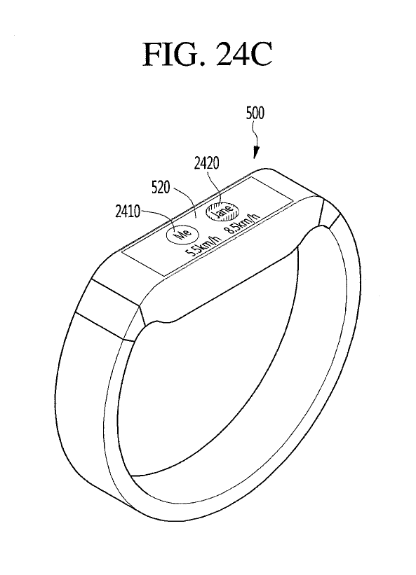

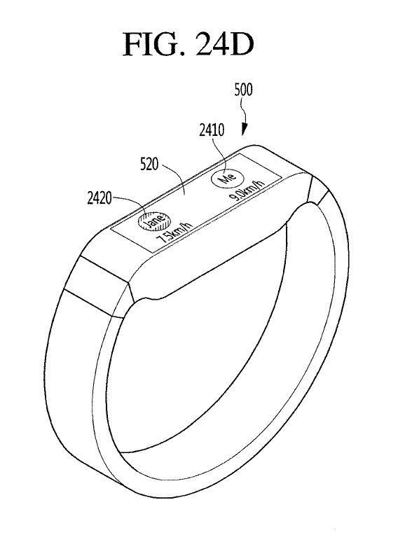

FIGS. 24 to 32 are diagrams illustrating a method of guiding an exercise of a user when the user selects a first mode.

FIGS. 24 to 26 are diagrams illustrating operation of the smartband 500 in a mode in which a user competes with a guider, according to an embodiment of the present disclosure.

Referring to FIG. 24, the smartband 250 may display at least one of a UI object 2410 corresponding to a user and a UI object 2420 corresponding to a guider.

On the other hand, the UI object 2410 corresponding to the user may be displayed together with current movement speed of the user, and the UI object 2420 corresponding to the guider may be displayed together with current movement speed of the guider.

Meanwhile, movement speed of the guider displayed when a first time has elapsed since the user started to exercise may be movement speed of the guider displayed at a time when the first time has elapsed since the guider started to exercise.

For example, when a current time is a time when 10 minutes has elapsed since the user started to exercise, the UI object 2410 corresponding to the user may be displayed together with movement speed of the user at a time when 10 minutes has elapsed since the user started to exercise, and the UI object 2420 corresponding to the guider may be displayed together with movement speed of the guider at a time when 10 minutes has elapsed since the guider started to exercise.

On the other hand, the UI object 2410 corresponding to the user and the UI object 2420 corresponding to the guider may be sequentially displayed in a specific direction according to rankings of the user and the guider.

For example, in a case in which the UI objects 2410 and 2420 are sequentially displayed from a right region to a left region of a screen according to rankings, when the user moves a distance of 1.2 km at a time when 10 minutes has elapsed since the user started to exercise and the guider moves a distance of 1 km at a time when 10 minutes has elapsed since the guider started to exercise, the UI object 2420 corresponding to the guider may be displayed in the left region of the screen with respect to the UI object 2410 corresponding to the user.

Meanwhile, a distance between the UI object 2410 corresponding to the user and the UI object 2420 corresponding to the guider may be proportional to a difference between a moment distance of the user at a time when a second time has been elapsed since the user started to exercise and a moment distance of the guider at a time when the second time has been elapsed since the guider started to exercise.

For example, when the user moves a distance of 1 km at a time when 10 minutes has elapsed since the user started to exercise and the guider moves a distance of 1.2 km at a time when 10 minutes has elapsed since the guider started to exercise, the distance between the UI object 2410 corresponding to the user and the UI object 2420 corresponding to the guider may be relatively widely displayed as illustrated in FIG. 24A.

On the contrary, when the user moves a distance of 1.5 km at a time when 15 minutes has elapsed since the user started to exercise and the guider moves a distance of 1.55 km at a time when 15 minutes has elapsed since the guider started to exercise, the distance between the UI object 2410 corresponding to the user and the UI object 2420 corresponding to the guider may be relatively narrowly displayed as illustrated in FIG. 24B.

FIG. 24C is a diagram illustrating a screen when a guider overtakes a user.

For example, the guider moves a distance of 2.5 km at a time when 20 minutes has elapsed since the guider started to exercise, and the user moves a distance of 2.4 km at a time when 20 minutes has elapsed since the guider started to exercise.

When the UI objects 2410 and 2420 are sequentially displayed from a right region to a left region of a screen according to rankings, the UI object 2410 corresponding to the user may be displayed in the left region of the screen with respect to the UI object 2420 corresponding to the guider.

Meanwhile, FIG. 24D is a diagram illustrating a screen when a user overtakes a guider. For example, the guider moves a distance of 4.0 km at a time when 30 minutes has elapsed since the guider started to exercise, and the user moves a distance of 4.25 km at a time when 30 minutes has elapsed since the user started to exercise.

When the UI objects 2410 and 2420 are sequentially displayed from a right region to a left region of a screen according to rankings, the UI object 2420 corresponding to the guider may be displayed in the left region of the screen with respect to the UI object 2410 corresponding to the user.

Meanwhile, the controller 180 may output a tactile signal for guiding an exercise of a user based on exercise information of the user and an exercise guide including information on am exercise pace of a guider. In addition, when a mode is the first mode (competing mode), the controller 180 may output a tactile signal for guiding a user to defeats a guider based on exercise information of the user and information on an exercise pace of the guider. Here, a winning condition may be that the user moves a certain course (or the same distance) in a shorter time than the guider moves.

For example, in FIG. 24A, since the user precedes the guider and movement speed of the user is equal to movement speed of the guider, the user may defeat the guider when the user maintains a current pace. Therefore, in FIG. 24A, the smartband 500 may not output any tactile signal.

Meanwhile, in FIG. 24B, since the user precedes the guider but movement speed (8.5 km/h) of the guider is greater than movement speed (5.5 km) of the user, the guider may overtake the user after a specific time.

In this case, the smartband 500 may output a tactile signal for guiding the user to increase movement speed. In this case, a method of outputting a tactile signal described with reference to FIGS. 3 to 20 may be intactly applied to a method of outputting the tactile signal for guiding the user to increase movement speed. For example, the smartband 500 may guide the user to more rapidly move by outputting vibration in the number of vibrations per unit time greater than the current number of walks per unit time of the user. In another example, the smartband 500 may guide the user to more rapidly move by outputting a plurality of vibrations in which an amplitude is increased or a period is decreased. In another example, the smartband 500 may output vibration at a period shorter than a step period of the guider.

On the other hand, the smartband 500 may output a tactile signal for guiding the user to increase movement speed until movement speed of the user becomes equal to a movement speed of the guider. For example, when movement speed of a guider is 8.5 km/h at a time when the first time has elapsed since the guider started to exercise, the smartband 500 may output a tactile signal for guiding a user to increase movement speed until movement speed of the user becomes 8.5 km/h at a time when the first time has elapsed since the user started to exercise. However, the present disclosure is not limited thereto, the smartband 500 may guide a distance between a user and a guider to be further increased, by outputting a tactile signal for guiding movement speed of the user to be greater than movement speed of the guider.

In this case, the smartband 500 may output a tactile signal for guiding an exercise pace of the user such that the distance between the user and the guider is maintained at a preset specific distance. For example, when the preset specific distance is 200 m, the smartband 500 may output a tactile signal for guiding the user to increase movement speed and then may stop output of the tactile signal when a movement distance of the user when the second time has elapsed since the user started to exercise is greater than a movement distance of the guider when the second time has elapsed since the guider started to exercise, by a distance of 200 m.

As described above, when a distance between a user and a guider is decreased in a state in which the user precedes the guider, the smartband 500 may allow the user to defeat the guider by guiding movement speed of the user to be equal to movement speed of the guider or guiding the movement speed of the user to be greater than the movement speed of the guider.

Meanwhile, Despite guiding of the smartband 500, when the guider overtakes the user, the smartband 500 may output a notification indicating that the guider overtakes the user.

On the other hand, when movement speed of the user is equal to movement speed of the guider, when the movement speed of the user is greater than the movement speed of the guider, or when a distance between the user and the guider is increased by a preset specific distance, the smartband 500 may guide an exercise pace of the user such that the user maintains current movement speed.

Meanwhile, the smartband 500 may output vibration in the number of vibrations per unit time that allows the user to move at the same speed as the movement speed of the guider. Specifically, the smartband 500 can acquire information on the number of walks per unit time in which the user moves at the same speed as movement speed of the guider, based on the movement speed of the guider and information on a stride of the user. In this case, the smartband may output vibration in the number of vibrations per unit time equal to the number of acquired walks per unit time.

On the other hand, FIG. 124C is a diagram illustrating a screen displaying a state in which a guider increases an exercise pace to overtake a user.

In this case, the smartband 500 may output a tactile signal for guiding the user to increase movement speed.

Meanwhile, in order for the user to overtake the guider, movement speed of the user should be greater than movement speed of the guider. Therefore, the smartband 500 may output a tactile signal for guiding the user to move at movement speed greater than movement speed of the guider.

On the other hand, the smartband 500 may display a plurality of movement speed at which the user overtakes the guider, and information on an elapsed time corresponding to each of the plurality of movement speeds, the elapsed time being a time elapsed until a movement distance of the user after the user starts to exercise is equal to a movement distance of the guider after the guider starts to exercise.

For example, the smartband 500 may display a first movement speed (for example, 9 km/h) at which the user overtakes the guider and a first elapsed time (for example, 2 minutes) required for the user to overtake the guide when the user moves at the first movement speed.

In addition, the smartband 500 may display a second movement speed (for example, 9.5 km/h) at which the user overtakes the guider and a second elapsed time (for example, 1 minute) required for the user to overtake the guide when the user moves at the second movement speed.

On the other hand, in a state in which the first movement speed and the first elapsed time are displayed, when a user touch input is received with respect to a region in which the first movement speed and the first elapsed time are displayed, the smartband 500 may output a tactile signal for guiding the user to move at the first movement speed. Similarly, in a state in which the second movement speed and the second elapsed time are displayed, when a user touch input is received with respect to a region in which the second movement speed and the second elapsed time are displayed, the smartband 500 may output a tactile signal for guiding the user to move at the second movement speed.

On the other hand, the plurality of movement speeds at which the user overtakes the guider may be provided in a preset speed unit. For example, the plurality of movement speeds at which the user overtakes the guider may be provided in a unit of 0.5 km/h (9.0 km, 9.5 km, 10 km, and the like).

On the other hand, when the user increases movement speed according to the guiding of the smartband 500 to overtake the guider, the smartband 500 can output a notification indicating that the user overtakes the guide.

Meanwhile, the smartband 500 may output a tactile signal for guiding the user to increase movement speed until the user overtakes the guider. That is, the smartband 500 may output a tactile signal for guiding the user to increase movement speed and then may stop output of the tactile signal when a movement distance of the user when the second time has elapsed since the user started to exercise is equal to a movement distance of the guider when the second time has elapsed since the guider started to exercise.

However, the present disclosure is not limited thereto, and even when the user overtakes the guider as illustrated in FIG. 24D, the smartband 500 may output a tactile signal for guiding an exercise pace of the user such that a distance between the user and the guider is greater than or equal to a preset specific distance. For example, when the preset specific distance is 200 m, the smartband 500 may output a tactile signal for guiding the user to increase movement speed and then may stop output of the tactile signal when a movement distance of the user when the second time has elapsed since the user started to exercise is greater than a movement distance of the guider when the second time has elapsed since the guider started to exercise, by a distance of 200 m.

As described above, when the guider precedes the user, the smartband 500 may guide movement speed of the user to be greater than movement speed of the guider, thereby allowing the user to defeat the guider.

Meanwhile, after the user overtakes the guider, when movement speed of the user is equal to or greater than movement speed of the guider, the smartband 500 may guide an exercise pace of the user such that the user maintains current movement speed.

In another example, when the user overtakes the guider but movement speed (9.0 km) of the user is still greater than movement speed (7.5 km) of the guider, the smartband 500 may outputting a tactile signal for guiding the user to exercise at the movement speed (7.5 km) of the guider. That is, the smartband 500 may prevent an over pace of the user by guiding movement speed of the user to be equal to movement speed of the guider and may guide an exercise pace of the user such that a distance between the user and the guider is maintained at a certain distance.

In another example, when the user overtakes the guider and a distance between the user and the guider is increased by a preset specific distance, the smartband 500 may guide an exercise pace of the user such that a current distance is maintained. That is, when the preset specific distance is 200 m, the smartband 500 may guide an exercise pace of the user such that a movement distance of the user after the user started to exercise is maintained to be greater than a movement distance of the guider after the guider started to exercise, by a distance of 200 m.

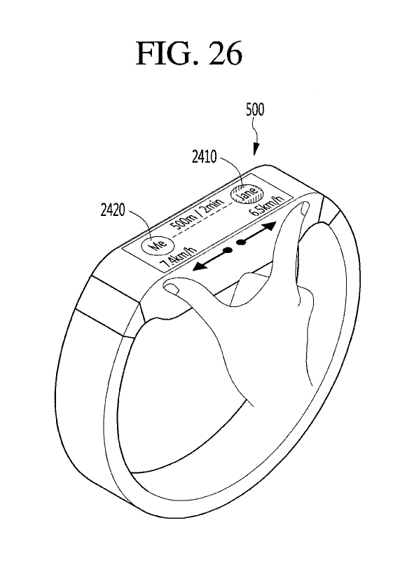

On the other hand, when a pinch-out input is received with respect to the display unit 520 of the smartband 500, the smartband 500 may display pace comparison information between the user and the guider acquired based on exercise information of the user and exercise information of the guider. This will be described in detail with reference to FIG. 26.

Meanwhile, in FIG. 24, it has been described that the UI object 2410 corresponding to the user and the UI object 2420 corresponding to the guider are moved and displayed, but the present disclosure is not limited thereto.

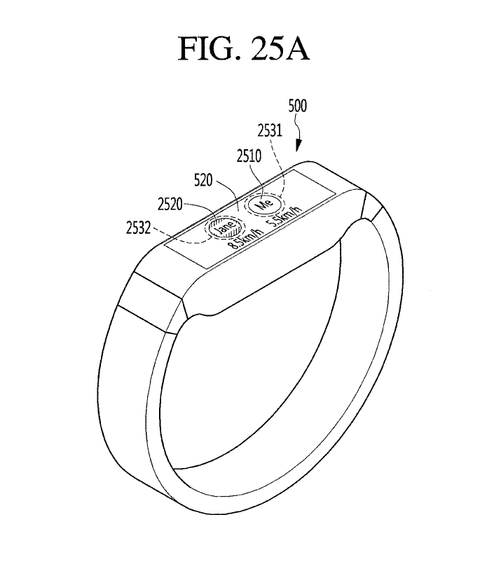

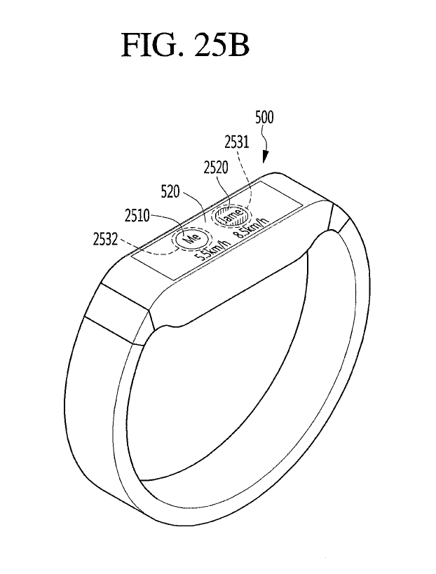

Specifically, as illustrated in FIGS. 25A and 25B, a plurality of UI objects 2510 and 2520 may be displayed in specific regions 2531 and 2532 on a screen.

In addition, the UI object 2510 corresponding to the user and the UI object 2520 corresponding to the guider may be sequentially displayed in a specific direction according to rankings between the user and the guider.

For example, in a case in which the UI objects 2510 and 2520 are sequentially displayed from a right region to a left region of a screen according to the rankings, when a movement distance of the user at a time when the first time has elapsed since the user started to exercise is greater than a movement distance of the guider at a time when the first time has elapsed since the guider started to exercise, as illustrated in FIG. 25A, the UI object 2510 corresponding to the user may be displayed in a first region 2531 of the specific regions 2531 and 2532, and the UI object 2520 corresponding to the guider may be displayed in a second region 2532 of the specific regions 2531 and 2532.

In another example, in a case in which the UI objects 2510 and 2520 are sequentially displayed from the right region to the left region of the screen according to the rankings, when a movement distance of the user at a time when the second time has elapsed since the user started to exercise is less than a movement distance of the guider at a time when the second time has elapsed since the guider started to exercise, as illustrated in FIG. 25B, the UI object 2520 corresponding to the guider may be displayed in the first region 2531 of the specific regions 2531 and 2532, and the UI object 2510 corresponding to the user may be displayed in the second region 2532 of the specific regions 2531 and 2532.

On the other hand, the controller 180 may change and display a color of the UI objects 2510 and 2520 based on movement speed of the user and a difference between movement speed of the guider and the movement speed of the user.

specifically, when the difference between the movement speed of the guider and the movement speed of the user is greater than or equal to a preset value, the smartband 500 may display a UI object corresponding to a person having higher movement speed in a first color and a UI object corresponding to a person having lower movement speed in a second color.

In addition, when the difference between the movement speed of the guider and the movement speed of the user is less than or equal to the preset value, the smartband 500 may display the UI object 2510 corresponding to the user and the UI object 2520 corresponding to the guider in a third color.

For example, when the preset value is 1 km/h, movement speed of the user at a time when the first time has elapsed since the user started to exercise is 5.5 km/h, and movement speed of the guider at a time when the first time has elapsed since the guider started to exercise is 8.5 km/h, one minute) since the guider started to exercise and the first time (one minute) has been elapsed since a user started to exercise, the smartband 500 may display the UI object 2510 corresponding to the user in a green color and the UI object 2520 corresponding to the guider in a red color.

In another example, when the preset value is 1 km/h, movement speed of the user at a time when the second time has elapsed since the user started to exercise is 7.5 km/h, and movement speed of the guider at a time when the second time has elapsed since the guider started to exercise is 7 km/h, the smartband 500 may display all of the UI object 2510 corresponding to the user and the UI object 2520 corresponding to the guider in a yellow color.

FIG. 26 is a diagram illustrating a method of displaying exercise comparison information, according to an embodiment of the present disclosure.

When a specific user input is received, the smartband 500 may display exercise comparison information of a user and a guider acquired based on exercise information of the user and exercise information of the guider.

Exercise comparison information of the user and the guider may include information on a distance between the user and the guider. For example, when a movement distance of the user at a time when 10 minutes has elapsed since the user started to exercise is 1 km and a movement distance of the guider at a time when 10 minutes has elapsed since the guider is 1.5 km, exercise comparison information displayed at a time when 10 minutes has elapsed since the user started to exercise may include information, i.e., “500 m”.

In addition, exercise comparison information of the user and the guider may include information on an estimated elapsed time until a movement distance of the user after the user starts to exercise is equal to a movement distance of the guider after the guider starts to exercise. Specifically, when the first time has elapsed since the user started to exercise, the smartband 500 may acquire and display an elapsed time until a movement distance of the user is equal to a movement distance of the guider, by using a movement distance and movement speed of the user at a time when the first time has elapsed since the user started to exercise and a movement distance and movement speed of the guider at a time when the first time has elapsed since the started to exercise.

For example, since the guider is currently ahead of the user by 500 meters but movement speed of the user is greater than movement speed of the guide, the user may overtake the guider after 2 minutes. Accordingly, pace compassion of the user and the guider may include information, i.e., “2 minutes”.

Meanwhile, the specific user input may be a pinch-out input with respect to the display unit 520. In addition, a region on a screen capable of receiving a pinch-out input may be a region between the UI object 2510 corresponding to the user and the UI object 2520 corresponding to the guider.

On the other hand, in a state in which a pinch-out input of the user is received and exercise comparison information of the user and the guider is displayed, when a pinch-in input of the user is received, the smartband 500 may display the screen in FIG. 24 or the screen in FIG. 25 again.

As ascribed above, according to the present disclosure, a user may be guided to exercise according to a specific guide by proving various modes. In addition, the user may be guided to defeat a specific guide.

In addition, in a competing mode, a user exercising at a different time from a guider may achieve the same effect as when the user competes with a guider in real time. In addition, an exercise of the user may be guided without interfering with the exercise of the user by outputting a signal for guiding the user to defeat the guider in the form a of a tactile signal.

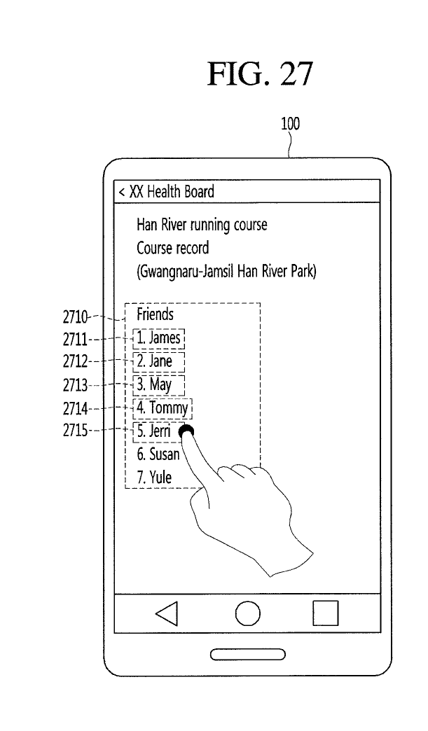

FIGS. 27 to 10 are diagrams illustrating operation of the smartband 500 in a mode in which a user competes with a plurality of guiders, according to an embodiment of the present disclosure.

As described with reference to FIG. 22, the controller 180 may display a user list 2710 of a plurality of mobile terminals.

Meanwhile, when a user input of selecting users 2711, 2712, 2713, 2714, and 2715 of two or more mobile terminals from displayed users of the plurality of mobile terminals is received, the controller 180 may receive exercise guides generated by the selected users of the mobile terminals from the server. On the other hand, exercise guides of the selected users of the mobile terminals may be stored in the memory 170 as described above.

The smartband 500 may guide an exercise pace in a mode (first mode) of competing with the users of the mobile terminals selected by user input.

Meanwhile, the mobile terminal 100 may transmit an exercise guide to the smartband 500, and the smartband 500 may guide an exercise of a user based on the received exercise guide and exercise information of the user.

In addition, when the mobile terminal 100 transmits an output or display command of a tactile signal to the smartband 500 based on exercise information of a user and an exercise guide, the smartband 500 may output or display the tactile signal based on the received output or display command of the tactile signal as described above.

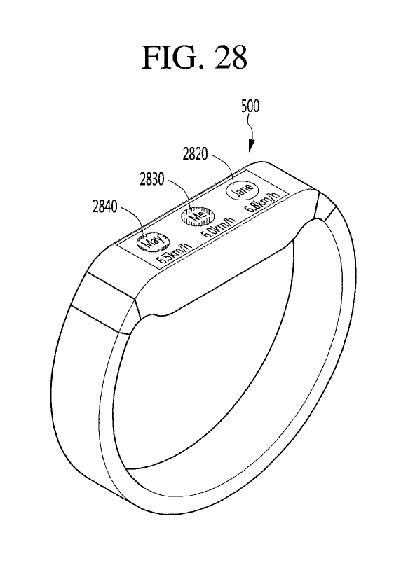

FIG. 28 is a diagram illustrating a screen displayed on the smartband 500 in a mode of competing which users of a plurality of mobile terminals.

The screen illustrated in FIG. 28 may be in a basic viewing mode and may be a display screen in a state in which a pinch-in or pinch-out input is not received.

In addition, the smartband 500 may display a UI object 2830 corresponding to a user and UI objects respectively corresponding to users of the plurality of mobile terminals.

Meanwhile, in the basic viewing mode, UI objects corresponding to two users of mobile terminals, whose current rankings are nearest to a ranking of the user of the smartband 500, may be displayed in the basic viewing mode.

For example, when a movement distance of the user at a time when the first time has elapsed since the user started to exercise is ranked third, a movement distance of Jane at a time when the first time has elapsed since Jane started to exercise is ranked second, and a movement distance of May at a time when the first time has elapsed since May started to exercise is ranked fourth, the smartband 500 may display a UI object 2820 corresponding to Jane and a UI object 2840 corresponding to May together with the UI object corresponding to the user of the smartband 500.

On the other hand, a plurality of UI objects 2820, 2839, and 2840 may be sequentially displayed in a specific direction according to rankings. For example, when the plurality of UI objects 2820, 2830, and 2840 are sequentially displayed from the right to the left of a screen according to rankings, the UI object 2830 corresponding to the user ranked third may be displayed in a left region of the UI object 2820 corresponding to Jane ranked second, and the UI object 2840 corresponding to May ranked fourth may be displayed in a left region of the UI object 2830 corresponding to the user ranked third.

Meanwhile, the UI object 2830 corresponding to the user may be displayed at a center of the screen.

On the other hand, a user name corresponding to each of the plurality of displayed UI objects 2820, 2830 and 2840 displayed may be displayed in the basic viewing mode. In addition, movement speed of the user corresponding to each of the plurality of displayed UI objects 2820, 2830, 2840 may be displayed.

On the other hand, in the present embodiment, it has been described that movement speed of the user corresponding to each of the plurality of displayed UI objects 2820, 2830, and 2840 is displayed, but the present disclosure is not limited thereto.

Specifically, in a state in which the movement speed of the user corresponding to each of the plurality of UI objects 2820, 2830, and 2840 is displayed, when a flicking input is received, the smartband 500 may display a relative distance between the user of the smartband 500 and the user corresponding to each of the plurality of UI objects 2820, 2830 and 2840. For example, when Jane is ahead of the user by 200 m and the user is ahead of May by 100 m, the UI object 2820 corresponding to Jane may be displayed together with information, i.e., “+200 m”, the UI object 2830 corresponding to the user may be displayed together with information, i.e., “0”, and the UI object 2840 corresponding to May may be displayed together with information, i.e., “−100 m”.

In another example, when a flicking input is received, the smartband 500 may display a relative time between the user of the smartband 500 and the user corresponding to each of the plurality of UI objects 2820, 2830 and 2840.

For example, when Jane passes through a point through which the user passes, more than 20 seconds ahead of the user and May is to pass through the point after 10 seconds, the smartband 500 may display the UI object 2820 corresponding to Jane together with information, i.e., “−20 seconds”, the UI object 2830 corresponding to the user together with information, i.e., “0 seconds”, and the UI object 2840 corresponding to May together with information, i.e., “+10 seconds”.

On the other hand, in the present embodiment, it has been described that the UI object 2830 corresponding to the user and the UI objects 2820 and 2830 corresponding to two users of the mobile terminals whose current rankings are nearest to a ranking of the user are displayed, but the present disclosure is not limited thereto. For example, in a case in which the UI objects 2830, 2840 and 2850 respectively corresponding to current ranking 2 (Jane), current ranking 3 (user), and current ranking 4 (May) are displayed, when a drag input (or a swipe input) of the user is received in a first direction, the smartband 500 may display the UI objects respectively corresponding to current ranking 2 (Jane), current ranking 3 (user), and current ranking 4 (May). In another example, in a case in which the UI objects 2830, 2840 and 2850 respectively corresponding to current ranking 2 (Jane), current ranking 3 (user), and current ranking 4 (May) are displayed, when a drag input (or a swipe input) of the user is received in a second direction opposite to the first direction, the smartband 500 may display UI objects respectively corresponding to current ranking 3 (user), current ranking 4 (user), and current ranking 4 (Tom).

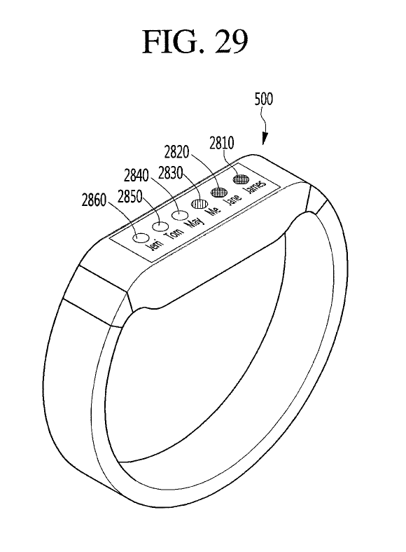

FIG. 29 is a diagram illustrating a screen displayed when a pinch-in input is received in a basic viewing mode.

The screen illustrated in FIG. 29 may be in a simple viewing mode and may be a display screen when a pinch-in input is received in a basic viewing mode.

The smartband 500 may display a UI object 2830 corresponding to a user and UI objects 2810, 2820, 2840, 2850, and 2860 respectively corresponding to users of a plurality of mobile terminals in the simple viewing mode.

Meanwhile, in FIG. 29, it has been described that a name of a user and names of users (hereinafter, referred to as virtual race participants) of a plurality of mobile terminals selected by the user are displayed, but the present disclosure is not limited thereto. Except for the names of the virtual race participants, only the UI objects 2810, 2820, 2840, 2850, and 2860 respectively corresponding to the virtual race participants may be displayed.

On the other hand, the UI objects 2810, 2820, 2840, 2850, and 2860 respectively corresponding to the virtual race participants may be sequentially displayed in a specific direction according to rankings as described above. That is, referring to FIG. 29, it may be seen that James is currently ranked first, Jane is currently ranked second, the user is currently ranked third, May is currently ranked fourth, and Tom is currently ranked fifth, and Jerri is ranked sixth.

On the other hand, in the present embodiment, it has been described that all the UI objects respectively corresponding to the virtual race participants are displayed, but the present disclosure is not limited thereto. For example, when six UI objects are preset so as to be displayed on the screen of the smartband 500 and the number of the virtual race participants is 10, the smartband 500 may display UI objects corresponding to six participants U (the user and five participants whose rankings are nearest to a ranking of the user).

For example, when the user is currently ranked fifth, the smartband 500 may display UI objects corresponding to ranking 3, ranking 4, ranking 5, ranking 6, ranking 7, and ranking 8 (or ranking 2, ranking 3, ranking 4, ranking 5, ranking 6, and ranking 7).

On the other hand, the UI object displayed on the screen among the 10 UI objects may be changed according to a drag input (or a swipe input) of the user. For example, in a state in which the UI objects corresponding to ranking 3, ranking 4, ranking 5, ranking 6, ranking 7, and ranking 8 are displayed, when a drag input is received in a first direction, the smartband 500 may display the UI objects corresponding to ranking 2, ranking 3, ranking 4, ranking 5, ranking 6, and ranking 7. In another example, in a state in which the UI objects corresponding to ranking 3, ranking 4, ranking 5, ranking 6, ranking 7, and ranking 8 are displayed, when a drag input is received in a second direction, the smartband 500 may display the UI objects corresponding to ranking 4, ranking 5, ranking 6, ranking 7, ranking 8, and ranking 9.

On the other hand, the UI object 2830 corresponding to the user and the UI objects 2810, 2820, 2840, 2850, and 2860 corresponding to users of other mobile terminals may be displayed in different colors.

The UI objects 2810 and 2820 corresponding to users of the users of other mobile terminals, which are ranked higher than the user, and the UI objects 2840, 2850 and 2860 corresponding to users ranked lower than the user may be displayed in different colors.

For example, the UI object 2830 corresponding to the user may be displayed in a red color, the UI objects 2840, 2850, and 2860 corresponding to the users ranked lower than the user may be displayed in a yellow color, and the UI objects 2810 and 2820 corresponding the users ranked higher than the user may be displayed in a green color.

On the other hand, when a pinch-in input of the user is received in the simple viewing mode, the smartband 500 may display a screen in the basic viewing mode illustrated in FIG. 28.

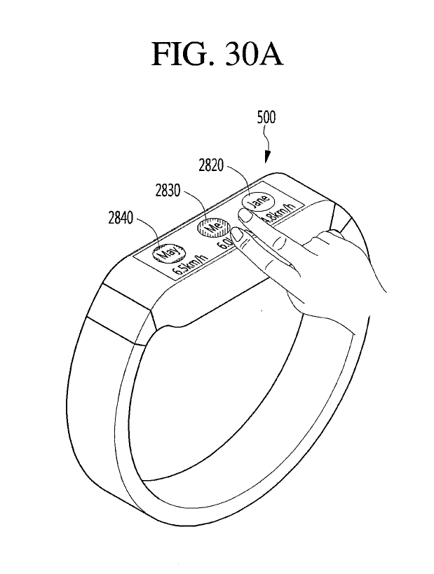

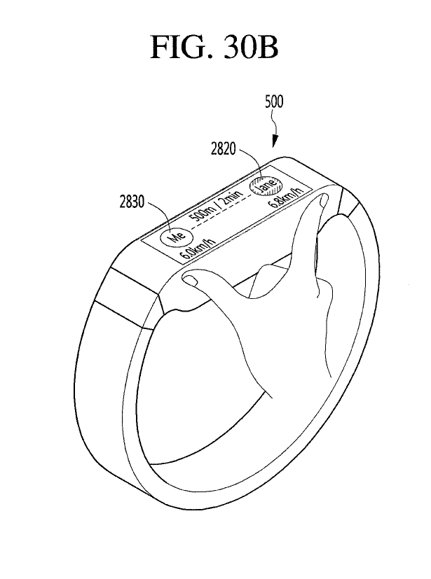

FIG. 30 is a diagram illustrating various display screens on the smartband 500 when a pinch-out input is received in a basic viewing mode.

As illustrated in FIG. 30A, in a state in which a UI object 2830 corresponding to a user, a UI object 2820 corresponding to a second mobile terminal user (Jane), and a UI object 2840 corresponding to a third mobile terminal user (May) are displayed, when a pin-out input is received with respect to a region between the UI object 2820 corresponding to the second mobile terminal user (Jane) and the UI object 2830 corresponding to the user, as illustrated in FIG. 30B, the smartband 500 may display exercise comparison information of the user and the second mobile terminal user (Jane) acquired based on exercise information of the user and exercise information of the second mobile terminal user (Jane).

The exercise comparison information of the user and the second mobile terminal user (Jane) may include information on a distance between the user and the second mobile terminal user (Jane).

In addition, the exercise comparison information of the user and the second mobile terminal user (Jane) may include information on an elapsed time until a movement distance of the user after the user starts to exercise is equal to a movement distance of a guider after the guider starts to exercise.

On the basis of current paces of the user and the second mobile terminal user (Jane), when a movement distance of the user after the user starts to exercise cannot be not equal to a movement distance of the guider after the guider starts to exercise, the smartband 500 may display a plurality of movement speeds at which the user overtakes the guider, and information on elapsed times respectively corresponding to the plurality of movement speeds, the elapsed times meaning an elapsed time until the movement distance of the user after the user starts to exercise is equal to the movement distance of the guider after the guider starts to exercise.

For example, when the second mobile terminal user (Jane) is ahead of the user in terms of a movement distance and movement speed (7.0 km) of the second mobile terminal user (Jane) is greater than movement speed (6.0 km/h) of the user, the user may not overtake second mobile terminal user (Jane) in the current pace. In this case, the smartband 500 may display first movement speed (for example, 7.5 km/h) at which the user overtakes the second mobile terminal user (Jane), and a first elapsed time (for example, 2 minutes) required for the user to overtake the second mobile terminal user (Jane) when the user moves at the first movement speed.

In addition, after the first movement speed and the first elapsed time are displayed, the smartband 500 may display second movement speed (for example, 8.0 km/h) and a second elapsed time (for example, 1 minute) required for the user to overtake the second mobile terminal user (Jane) when the user moves at the second movement speed.

On the other hand, in a state in which the first movement speed and the first elapsed time are displayed, when a user touch input is received with respect to a region in which the first movement speed and the first elapsed time are displayed, the smartband 500 may output a tactile signal for guiding the user to move at the first movement speed. Similarly, in a state in which the second movement speed and the second elapsed time are displayed, when a user touch input is received with respect to a region in which the second movement speed and the second elapsed time are displayed, the smartband 500 may output a tactile signal for guiding the user to move at the second movement speed.

On the other hand, in the present embodiment, it has been described that in a state in which the UI object 2830 corresponding to the user, the UI object 2820 corresponding to the second mobile terminal user (Jane), and the UI object 2840 corresponding to the third mobile terminal user (May) are displayed, a pin-out input is received with respect to a region between the UI object 2820 corresponding to the second mobile terminal user (Jane) and the UI object 2830 corresponding to the user, but the present disclosure is not limited thereto.

For example, when a pinch-out input is received with respect to a region between the UI object 2830 corresponding to the user and the UI object 2840 corresponding to the third mobile terminal user (May), the smartband 500 may display exercise comparison information of the user and the third mobile terminal user (May) acquired based on exercise information of the user and exercise information of the third mobile terminal user (May).

Meanwhile, when a user input of selecting one of the plurality of displayed UI objects is received, the smartband 500 may display detail information on an exercise of the user corresponding to the UI object selected by the user.

For example, in FIG. 28, when a user input of selecting the UI object 2830 corresponding to the user of the smartband 500 is received, the smartband 500 may display detail information on an exercise of the user of the smartband 500.

In another example, in FIG. 29, when a user input of selecting the UI object 2860 corresponding to Jerri is received, the smartband 500 may display detail information on an exercise of Jerri. Here, the detail information on the exercise of Jerri may be information included in an exercise guide of Jerri.

On the other hand, detail information on an exercise displayed at a time when a specific time has elapsed since the start of the exercise may include at least one of the specific time elapsed since the start of the exercise and a movement distance/average speed/maximum speed/consumed calorie amount/required moisture intake/minimum altitude/maximum altitude/slope information at a time when the specific time has elapsed since the start of the exercise.

In addition, detail information on an exercise displayed at a time when a specific time has elapsed since the start of the exercise may include information on at least one of a rating, movement speed, and a heart rate at a time when the specific time has elapsed since the start of the exercise.

On the other hand, in the present embodiment, it has been described that when one of a plurality of displayed UI objects is selected, detail information on an exercise is displayed, but the present disclosure is not limited thereto.

For example, when only one UI object is displayed according to a user pinch-out input while a plurality of UI objects are displayed, the smartband 500 may display detail information on an exercise of a user corresponding to the displayed one UI object.

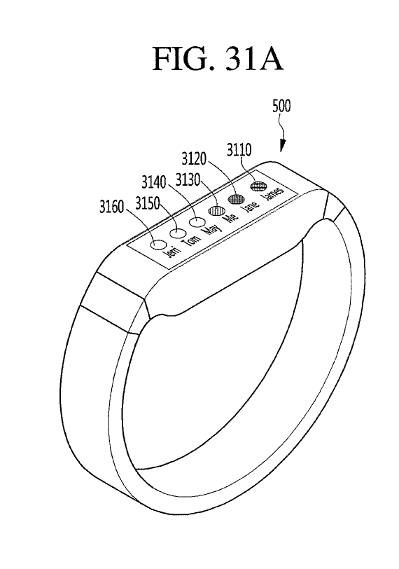

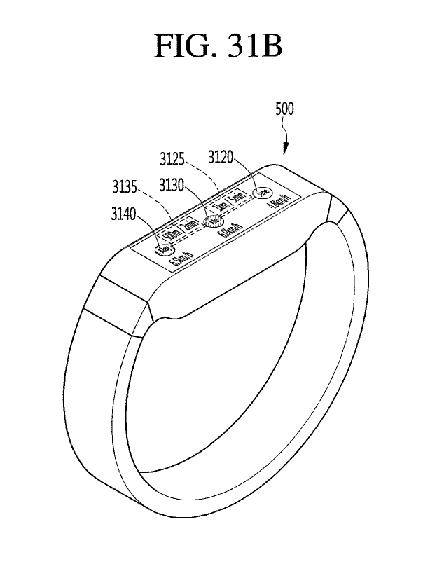

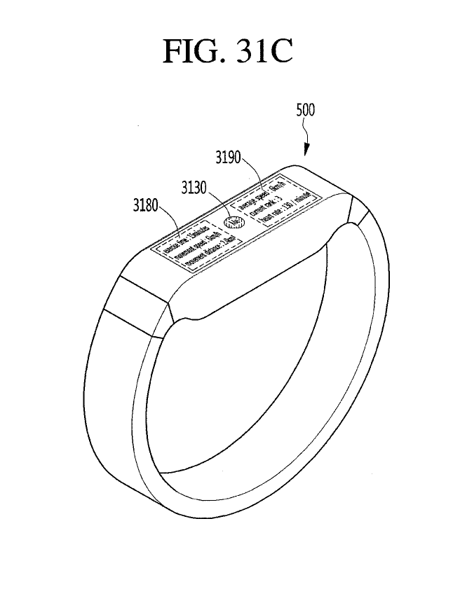

FIG. 31 is a diagram illustrating operation of the smartband 500 in a mode in which a user competes with a plurality of guiders, according to another embodiment of the present disclosure.

The smartband 500 may display a UI object 3130 corresponding to a user and UI objects 3110, 3120, 3140, 3150, and 3160 respectively corresponding to users of a plurality of mobile terminals in a simple viewing mode as in FIG. 31A.

On the other hand, when a user pinch-in input is received with respect to a screen of the smartband 500, as illustrated in FIG. 31B, the smartband 500 may display the UI object 3130 corresponding to the user of the smartband 500 and the UI objects 3120 and 3140 corresponding to two users of the mobile terminals whose current rankings are nearest to a ranking of the user of the smartband 500.

In this case, the object 3130 corresponding to the user of the smartband 500 may be displayed at a center of the screen.

In addition, the smartband 500 may display exercise comparison information 3125 of the user and the second mobile terminal user (Jane) and exercise comparison information 3135 of the user and the third mobile terminal user (May).

On the other hand, when a pinch-out input of the user is additionally received on the screen of FIG. 31B, as illustrated in FIG. 31C, the smartband 500 may display the object 3130 corresponding to the user of the smartband 500. In addition, the smartband 500 may display pieces of detail information 3180 and 3190 on an exercise of the user of the smartband 500.

On the other hand, when the user is in a mode of competing with a plurality of guiders, the controller 180 may output a tactile signal for indicating information on a change in a ranking. For example, when the user overtakes any one of the plurality of guiders, or when any one of the plurality of guiders overtakes the user, the controller 180 may output vibration. However, the present disclosure is not limited thereto, and vibration for indicating information on a change in a ranking may be output even when there is a change in a ranking between guiders.

On the other hand, when the user is in a mode of competing with a plurality of guiders, the user may compete with a specific guider designated by the user. Specifically, when a user input of selecting a specific guider from a plurality of guiders (James, Jane, May, Tom, and Jerri) is received, the smartband 500 may output a tactile signal for guiding an exercise of the user such that the user defeats the specific guider based on information on an exercise pace of the specific guider and exercise information of the user.

In this case, the user input of selecting the specific guider may be a user input of selecting one of the objects respectively corresponding to a plurality of guiders (James, Jane, May, Tom, and Jerri). For example, when a user touch input is received with respect to the object corresponding to Jane, the smartband 500 may output a tactile signal for guiding an exercise of the user such that the user defeats Jane.

Meanwhile, all methods of outputting a tactile signal illustrated in FIGS. 23 and 26 may be applied to a method of outputting a tactile signal for guiding the user to defeat a specific guider.

On the other hand, the guider competing with the user may be changed during an exercise of the user. For example, when the user competing with Jerri is significantly ahead of Jerri and thus looks for a new competitor, the user may change a competitor by selecting another guider (for example, James ahead of the user).

On the other hand, when the user is in a mode of competing with a plurality of guiders, the user may compete with the plurality of guiders. For example, the smartband 500 may guide an exercise of the guider such that the user defeats the plurality of guiders (James, Jane, May, Tom, and Jerri).

However, the smartband 500 may output a tactile signal for guiding the user to defeat a guider who is ranked higher than the user and whose ranking is nearest to a ranking of the user, based on an excise guide of the guider who is ranked higher than the user and whose ranking is nearest to the ranking of the user.

For example, when the user is currently ranked sixth, the smartband 500 may output a tactile signal for guiding the user to defeat a guider currently ranked fifth. In addition, when the user is currently ranked second, the smartband 500 may output a tactile signal for guiding the user to defeat a guider currently ranked first. Meanwhile, when the user is currently ranked first, the smartband 500 may output a tactile signal for guiding the user not to be defeat by a guider currently ranked second.

Meanwhile, all methods of outputting a tactile signal illustrated in FIGS. 23 and 26 may be applied to a method of outputting a tactile signal for guiding the user to defeat a guider currently who is ranked higher than the user and whose ranking is nearest to a ranking of the user, and a method of outputting a tactile signal for guiding currently ranked first not to be defeated a guider currently ranked second.

On the other hand, even while the user is competing with a plurality of users, the smartband 500 may output a tactile signal for guiding the user to exercise at an exercise pace of a specific guider. Specifically, when a mode is set to a “competing” mode with the specific guider of the plurality of guiders and is set to a “following” mode with the remaining guiders of the plurality of guiders, the smartband 500 may output a tactile signal for guiding the user to exercise at an exercise pace of the specific guide. For example, when the user sets a mode in which the user follows a guider of a plurality of guiders, who won first place, and sets a mode in which the user competes with the remaining guiders, the smartband 500 may guide the user to win first place by guiding the user to exercise at an exercise pace of the guider who won first place.

As described above, the present disclosure may provide the same effect as when a user competes with users of a plurality of other mobile terminals in real time.

In addition, according to the present disclosure, an exercise of the user may be guided without interfering with the exercise of the user by outputting a tactile signal for guiding the user to defeat a specific guider of a plurality of guiders.

In addition, according to the present disclosure, a tactile signal for guiding a user to defeat a subject may be output when the user changes the subject, thereby providing an environment in which the user freely changes a competitor according to a situation of the user.

Meanwhile, the present disclosure may be implemented by executing an application installed in a mobile terminal or a watch-type mobile terminal. Such an application may be obtained in a manner in which a mobile terminal or a watch-type mobile terminal receives and stores the application from a server. When the application is obtained, the controller 180 may implement the above-described disclosure in a mobile terminal or a watch-type mobile terminal by driving the obtained application.

On the other hand, the controller 180 is generally configured to control an apparatus, and may be interchangeably used with the terms such as a central processing unit, a microprocessor and a processor.

The present disclosure mentioned in the foregoing description may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The processor may include the controller 180 of the mobile terminal.

1. An operating method of a watch-type mobile terminal, the operating method comprising:
acquiring an exercise guide comprising information on an exercise pace of a guider;
acquiring exercise information of a user; and
outputting a tactile signal for guiding the user to exercise at the exercise pace of the guider based on the exercise guide and the exercise information.

2. The operating method according to claim 1, wherein the exercise guide comprises information on a plurality of positions on a movement route of the guider and information on a plurality of exercise paces respectively corresponding to the plurality of positions, and
the outputting of the exercise information comprises outputting the tactile signal for guiding the user located at a first position of the plurality of positions to exercise at an exercise pace of the guider corresponding to the first position based on position information of the user included in the exercise information.

3. The operating method according to claim 2, wherein the information on the plurality of exercise paces respectively corresponding to the plurality of positions is information on a plurality of movement speeds respectively corresponding to the plurality of positions, and
the outputting of the exercise information comprises outputting the tactile signal for guiding the user located at the first position of the plurality of positions to exercise at movement speed of the guider corresponding to the first position.

4. The operating method according to claim 3, wherein the exercise information comprise information on movement speed of the user, and
the outputting of the exercise information comprises outputting a plurality of vibrations in which an amplitude is increased or a period is decreased, when movement speed of the user at the first position of the plurality of positions is less than the movement speed of the guider corresponding to the first position, and outputting a plurality of vibrations in which an amplitude is decreased or a period is increased, when the movement speed of the user at the first position of the plurality of positions is greater than the movement speed of the guider corresponding to the first position.

5. The operating method according to claim 2, wherein the information on the plurality of exercise paces respectively corresponding to the plurality of positions is information on the number of motions per unit time corresponding to each of the plurality of positions,
the outputting of the exercise information comprises outputting the tactile signal for guiding the user located at the first position of the plurality of positions to exercise in the number of motions per unit time of the guider corresponding to the first position, and
the number of motions per unit time is the number of walks per unit time or the number of rotations per unit.

6. The operating method according to claim 2, wherein the information on the plurality of exercise paces respectively corresponding to the plurality of positions is information on steps of the guider in a plurality of courses respectively corresponding to the plurality of positions, and the outputting of the exercise information comprises outputting the tactile signal corresponding to a step of the guider in a course corresponding to the first position when the user is located at the first position of the plurality of positions.

7. The operating method according to claim 2, wherein the exercise guide comprises information on a plurality of times elapsed since the guider started to exercise, and information on a plurality of exercise paces respectively corresponding to the plurality of times, and
the outputting of the exercise information comprises outputting the tactile signal for guiding the user at a time when a first time has elapsed since the user started to exercise to exercise at an exercise pace of the guider at a time when the first time of the plurality of times elapsed since the guider started to exercise.

8. The operating method according to claim 1, wherein the outputting of the exercise information comprises correcting the exercise pace of the guider when an exercise pace of the user in a specific course is different from the exercise pace of the guider in the specific course; and
outputting the tactile signal for guiding an exercise pace of the user after the specific course based on the corrected exercise pace of the guider.

9. The operating method according to claim 1, wherein the acquiring of the exercise guide comprises:
receiving pieces of information respectively corresponding to a plurality of exercise guides from a server;
displaying the received pieces of information respectively corresponding to the plurality of exercise guides;
receiving an user input of selecting information corresponding to a specific exercise guide from the displayed pieces of information respectively corresponding to the plurality of exercise guides; and
receiving the specific exercise guide selected by the user input from the server.

10. The operating method according to claim 9, wherein the pieces of information respectively corresponding to the plurality of exercise guides comprises information on at least one of an exercise type, an exercise course, an exercise distance, an exercise time, and a physical condition of a guider corresponding to each of the plurality of exercise guides, and
the guider corresponding to each of the plurality of exercise guides is a user of each of a plurality of mobile terminals which respectively generate the plurality of exercise guides.

11. The operating method according to claim 1, further comprises
storing an exercise guide comprising the exercise information of the user; and
transmitting the stored exercise guide to a server,
wherein the exercise information of the user comprises information on a plurality of positions on a movement route of the user and information on a plurality of exercise paces respectively corresponding to the plurality of positions, or information on a plurality of times elapsed since the user started to exercise and information on a plurality of exercise paces respectively corresponding to the plurality of times.

12. The operating method according to claim 1, wherein the information on the exercise pace of the guider is information on an exercise pace acquired based on past exercise information of the user, or information on an exercise pace acquired based on exercise information of a user of other mobile terminal.

13. A watch-type mobile terminal comprising:
a sensing unit configured to sense a motion of a user;
an output unit configured to output a tactile signal; and
a controller configured to control the output unit to output a tactile signal for guiding the user to exercise at an exercise pace of the guider by using exercise information of the user acquired based on an exercise guide comprising information on the exercise pace of the guider and the sensed motion of the user.

14. The watch-type mobile terminal according to claim 13, further comprising a wireless communication unit configured to receive position information of the user,
wherein the exercise guide comprises information on a plurality of positions on a movement route of the guider and information on a plurality of exercise paces respectively corresponding to the plurality of positions, and
the controller outputs the tactile signal for guiding the user located at a first position of the plurality of positions to exercise at an exercise pace of the guider corresponding to the first position based on position information of the user included in the exercise information.

15. The watch-type mobile terminal according to claim 13, further comprising:
a wireless communication unit configured to communicate with a server;
an input unit configured to receive a user input; and
a display unit configured to display an image,
wherein the controller receives pieces of information respectively corresponding to a plurality of exercise guides from a server, displays the received pieces of information respectively corresponding to the plurality of exercise guides, receiving an user input of selecting information corresponding to a specific exercise guide from the displayed pieces of information respectively corresponding to the plurality of exercise guides, and receives the specific exercise guide selected by the user input from the server.
